(19) United States
(12) Patent Application Publication
(10) Pub. No.: US 2006/0036640 A1
(43) Pub. Date: Feb. 16, 2006

(54) Information processing apparatus, information processing method, and program

(75) Inventors: Kei Tateno, Kanagawa (JP); Noriyuki Yamamoto, Kanagawa (JP); Mari Saito, Kanagawa (JP); Mitsuhiro Miyazaki, Kanagawa (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Sony Corporation, Tokyo (JP)

(21) Appl. No.: 11/190,858

(22) Filed: Jul. 28, 2005

(30) Foreign Application Priority Data
Aug. 3, 2004 (JP) 2004-226788

(51) Int. Cl. G06F 17/00

(52) U.S. Cl. 707/102

(57) ABSTRACT

The present invention enables execution of the processing using metadata such as content recommendation in consideration to cooccurrence relation among metadata. A matrix generating section generates a metadata matrix having N rows corresponding to N metadata (N: integral number of 1 or more) respectively and M columns corresponding to M metadata (M: integral number of 1 or more). A LSA computing section generated an approximated matrix of a metadata matrix by subjecting the metadata matrix to singular value decomposition. The metadata extracting section computes, for each of the N metadata, an index value such as a feature difference indicating importance of metadata corresponding to the metadata above, and extracts important metadata or unnecessary metadata from among the N metadata. The present invention may be applied to an information processing apparatus for content recommendation.

### BACKGROUND OF THE INVENTION

The present invention relates to an information processing apparatus, an information processing method, and a program for the same. More specifically to an information processing apparatus, an information processing method, and program which are capable of executing processing making use of metadata such as recommendation of contents by in consideration to of cooccurrence relation of metadata.

Recently there has been becoming more and more popular a system recommending contents to a user (hereinafter described as a content recommendation system) as one of information processing apparatus.

Descriptions are provided below for outline of a sequential processing (hereinafter described as content recommendation processing) executed by a prior art-based content recommendation system for recommendation of contents.

For the purpose to simplify descriptions, it is assumed in the following descriptions that all steps of the content recommendation processing are executed by one information processing apparatus.

At first, an information processing apparatus executes vectorization of content by referring to metadata assigned to the content as a base vector. This type of vector is described as content vector hereinafter.

Then the information processing apparatus generates a plurality of content vectors as described above, and further generates a matrix in which the plurality of content vectors are arrayed in prespecified directions respectively, namely a matrix including the plurality of content vectors as row components and as column components. The matrix as described above is described as a metadata matrix hereinafter. Further a space based on metadata as a base vector and formed with all of the metadata is described as a metadata space.

The information processing apparatus performs weighting (give a weight value) to each component in the metadata matrix by a prespecified weighting technique. As a technique for weighting, a weighting technique making use of the TF/IDF method using a frequency of appearance of metadata in contents, exhaustiveness or specificity of metadata in contents is widely used. The TF/IDF method uses a product of a frequency of metadata included in contents (TF) multiplied by an inverse number of the number of contents including the metadata (IDF).

As described above, each column component or each row component in a metadata matrix, namely a content vector is converted to a content vector properly weighted according to metadata.

Further the information processing apparatus generates a vector indicating a user's preference by making use of one or more weighted content vectors. A vector indicating a user's preference is described as a user preference vector (UPV) hereinafter.

The information processing apparatus computes similarity as expressed by the cosine function between the UPV and feature vectors corresponding to a plurality of contents not experienced yet by a user respectively (performs the matching processing), and recommends contents in the descending order of the similarity.

Outline of the content recommendation processing in the prior art-based content recommendation system is as described above.

Recently there has been established a technique for performing matching in a dimension-compressed space by making use of the technique called LSA (Latent Semantic Analysis) (Refer to non-patent documents 1 to 3, and patent document 1). The technique using the LSA has achieved substantially satisfactory results as a technique for classifying or searching documents by in consideration of semantic correlation between words.

Also the technique using the LSA may be applied to the content recommendation processing.

In other words, when the information processing apparatus executes singular value decomposition to the metadata as described above, as a result, a conceptual space, in which a plurality of metadata highly correlated to each other are grouped on one dimension, is generated from the metadata space. Singular values (each indicating importance of each base) are correlated to bases in the conceptual space respectively. When the information processing apparatus executes reverse projection to the metadata space using only upper bases each having a large singular value (dimensional compression), as a result, a matrix clearly showing correlation between metadata is generated. The matrix described above is hereinafter described as an approximated matrix.

The processing sequence described above is generally referred to as LSA, and the information processing apparatus can also perform the matching processing for contents using the approximated matrix generated by LSA in place of the metadata matrix.

Non-patent document 1: U.S. Pat. No. 4,839,853

Non-patent document 2: U.S. Pat. No. 5,301,109

Non-patent document 3: S. C. Deerwester, S. T. Dumais, T. K. Landauer, G. W. Furnas, and R. A. Harshman, “Indexing by latent semantic analysis.”, Journal of the American Society of Information Science, 41 (6): 391-407, 1990

Patent document 1: Japanese Patent Laid-Open No. Hei 11-296552

### SUMMARY OF THE INVENTION

In the prior art-based content recommendation system making use of metadata as described above, when treating documents (such as mails or Web sites) based on natural language as contents, namely when recommending textual data, a word appearing in a text is treated as metadata. Therefore the number of words increases in association with a volume of documents to be treated, namely dimensions of a metadata space increase, which sometimes disables computing. To solve the problem described above, it has been tried to reduce the number of words based on a weight of each word. However, when the TF/TDF technique is employed, for example, cooccurrence relation (or synonymy) between metadata (words) is not taken into consideration, and sometimes a word not to be deleted is often deleted disadvantageously.

Further in the fields of data mining and document classification, when sorting is executed according to an attribute (metadata) sometimes called as feature selection, whether or not each data is to be employed is generally decided according to statistic or information logic numerical values (such as a logarithmic likelihood ratio or an X² value, and a mutual information amount with each classification class), and also in this case the cooccurrence relation of metadata (attribute) is not taken into consideration.

Further also in recommendation of contents, cooccurrence of measurement data is not taken into consideration, and only as weight in a metadata matrix obtained by the TF/IDF, or a weight on an approximated matrix obtained as a result of dimensional compression of a metadata matrix by LSA is used, and in either method, only contents similar to known ones (experienced or highly evaluated by a user) can be recommended, which is disadvantageous.

As described above, it is desirable to enable execution of the processing making use of metadata such as recommendation of contents by in consideration of cooccurrence of metadata. The present invention was made in the light of the circumstances.

The information processing apparatus according to the present invention includes: a matrix generating unit; an approximated matrix generating unit; an index value computing unit; and an extracting unit. The matrix generating unit vectorizes each of M (integral value of 1 or more) contents among a plurality of contents referring to N (integral value of 1 or more) metadata correlated to at least one of the plurality of contents, and generates a matrix including M vectors obtained as a result of vectorization as column components or row components as a metadata matrix. The approximated matrix generating unit generates an approximated matrix for the metadata matrix by subjecting the metadata matrix generated by the matrix generating unit to singular value decomposition. The index value computing unit computes an index value indicating importance of corresponding metadata for each of the N metadata based on a difference between the metadata matrix generated by the matrix generating unit and the approximated matrix generated by the approximated matrix generating unit. The extracting unit extracts at least one from the N metadata as important metadata having high importance or unnecessary metadata having low importance based on the N index values computed by the index value computing unit.

The index value computing unit can successively set the N metadata as remarked metadata respectively, compute difference values between each of the M row or column component values indicating remarked metadata in the approximated matrix and a corresponding component value in the metadata matrix, and compute an average value of or a maximum value among the computed M difference values as an index value indicating importance of the remarked metadata.

The index value computing unit can successively set N metadata as remarked metadata respectively, compute quotients obtained by dividing M row or column component values indicating remarked metadata in the approximated matrix by a corresponding component value in the metadata matrix, and compute an average value of or a maximum value among the computed M quotients as an index value indicating importance of the remarked metadata.

The information processing apparatus according to the present invention may further include: a recommending unit for deciding one or more contents to be recommended to a user from among a plurality of contents making use of the important metadata extracted by the extracting unit or metadata excluding unnecessary data extracted by the extracting unit among the N metadata; and a presenting unit for presenting the contents decided by the recommending unit as those to be recommended to the user.

The information processing apparatus according to the present invention may further include a presenting unit for presenting the important metadata or unnecessary metadata extracted by the extracting unit to the user.

The information processing apparatus according to the present invention may still further include a storage unit for storing the important metadata or unnecessary metadata extracted by the extracting unit.

An information processing method according to the present invention includes: a matrix generating step, an approximated matrix generating step, an index value computing step; and an extracting step. The matrix generating step vectorizes each of M (integral value of 1 or more) contents among a plurality of contents based on N (integral value of 1 or more) metadata correlated to at least one of the plurality of contents, and generates a matrix including M vectors obtained as a result of vectorization as column components or row components as a metadata matrix. The approximated matrix generating step generates an approximated matrix for the metadata matrix by subjecting the metadata matrix generated in the matrix generating step to singular value decomposition. The index value computing step computes an index value indicating importance of corresponding metadata for each of the N metadata based on a difference between the metadata matrix generated in the matrix generating step and the approximated matrix generated in the approximated matrix generating step. The extracting step extracts at least one from the N metadata as important metadata having high importance or unnecessary metadata having low importance based on the N index values computed in the index value computing step.

A program according to the present invention executed by a computer includes: a matrix generating step, an approximated matrix generating step, an index value computing step; and an extracting step. The matrix generating step vectorizes each of M (integral value of 1 or more) contents among a plurality of contents based on N (integral value of 1 or more) metadata correlated to at least one of the plurality of contents, and generates a matrix including M vectors obtained as a result of vectorization as column components or row components as a metadata matrix. The approximated matrix generating step generates an approximated matrix for the metadata matrix by subjecting the metadata matrix generated in the matrix generating step to singular value decomposition. The index value computing step computes an index value indicating importance of corresponding metadata for each of the N metadata based on a difference between the metadata matrix generated in the matrix generating step and the approximated matrix generated in the approximated matrix generating step. The extracting step extracts at least one from the N metadata as important metadata having high importance or unnecessary metadata having low importance based on the N index values computed in the index value computing step.

With the information processing apparatus, information processing method, and program according to the present invention, based on N (integral value of 1 or more) metadata correlated to at least one of a plurality of contents, M (integral value of 1 or more) contents among the plurality of contents are vectorized to generate a matrix including M vectors obtained as a result of vectorization as column components or row components as a metadata matrix. Further, singular value decomposition is executed to the metadata matrix to generate an approximated matrix of the metadata matrix. Further, based on a difference between the metadata matrix and the approximated matrix, an index value indicating importance of metadata corresponding to each of the N metadata is then computed, and based on the N computed index values, at least one metadata is extracted from the N metadata as important metadata having high importance or unnecessary metadata having low importance.

As described above, the present invention allows for treating metadata of contents. Especially, the present invention allows for computing an index value indicating importance of metadata in consideration of the cooccurrence relation of the metadata to extract unnecessary metadata or important metadata based on the index value. This enables processing using metadata such as content recommendation in consideration of cooccurrence relation of the metadata.

### BRIEF DESCRIPTION OF THE DRAWINGS

FIG. 1 is a functional block diagram showing an example of functional configuration of an information processing system according to the present invention;

FIG. 2 is a functional block diagram showing the information processing system shown in FIG. 1 from the view point of information flow when carrying out “unnecessary metadata extracting processing in consideration of cooccurrence relation”;

FIG. 3 is a flow chart illustrating the “unnecessary metadata extracting processing in consideration of cooccurrence relation” executed by the information processing system shown in FIG. 2;

FIG. 4 is an example showing a processing result of the “unnecessary metadata extracting processing in consideration of cooccurrence relation” shown in FIG. 3;

FIG. 5 is another example showing a processing result of the “unnecessary metadata extracting processing in consideration of cooccurrence relation” shown in FIG. 3;

FIG. 6 is still another example showing a processing result of the “unnecessary metadata extracting processing in consideration of cooccurrence relation” in FIG. 3;

FIG. 7 is a functional block diagram showing the information-processing system in FIG. 1 from the view point of information flow when carrying out the “recommending processing in consideration of cooccurrence relation”;

FIG. 8 is a flowchart showing the “recommending processing in consideration of cooccurrence relation” executed by the information-processing system in FIG. 7;

FIG. 9 is a functional block diagram showing the information processing system in FIG. 1 from the view point of information flow when carrying out the “recommending processing based on differences between clustered UPV groups”;

FIG. 10 is a flowchart showing the “recommending processing based on differences between clustered UPV groups” executed by the information processing system in FIG. 9;

FIG. 11 is a functional block diagram showing the information processing system shown in FIG. 1 from the view point of information flow when executing “contents re-evaluating processing by LSA”;

FIG. 12 is a flow chart showing the “contents re-evaluating processing by LSA” executed by the information processing system in FIG. 11;

FIG. 13 shows an example illustrating a processing result of the “contents re-evaluating processing by LSA” in FIG. 11;

FIG. 14 shows another example illustrating a processing result of the “contents re-evaluating processing by LSA” in FIG. 11;

FIG. 15 shows another example illustrating a processing result of the “contents re-evaluating processing by LSA” in FIG. 11;

FIG. 16 shows still another example illustrating a processing result of the “contents re-evaluating processing by LSA” in FIG. 11;

FIG. 17 is a functional block diagram showing the information processing system in FIG. 1 from the view point of information flow when executing the “recommending processing by a hybrid of LSA and another technique”;

FIG. 18 is a flow chart illustrating the “recommending processing by a hybrid of LSA and another technique” executed by the information processing system in FIG. 17; and

FIG. 19 is a block diagram showing an example of hardware composition of the information processing apparatus (at least a portion of the information-processing system in FIG. 1) according to the present invention.

### DETAILED DESCRIPTION OF THE PREFERRED EMBODIMENTS

Embodiments of the present invention will be described hereinafter, where components described in claims and examples in the preferred embodiments of the present invention are correlated as described below. This description confirms that examples supporting inventions described in claims are described in the embodiments of the present invention. Therefore, if there is an example described in the embodiments of the present invention but not described herein as what corresponds to a component, it does not mean that the example does not correspond to the component. On the contrary, if an example is described herein as what corresponds to a component, it does not mean that the example does not correspond to other components than the described component, either.

Further, this description does not mean that all of the inventions correlated to examples described in the embodiment of the present invention are fully described in claims. In other words, this description describes an invention correlated to the examples described in the embodiment of the present invention, but does not deny other inventions not described in claims attached hereto, or inventions to be applied by divisional application or to be added by amendment in the future.

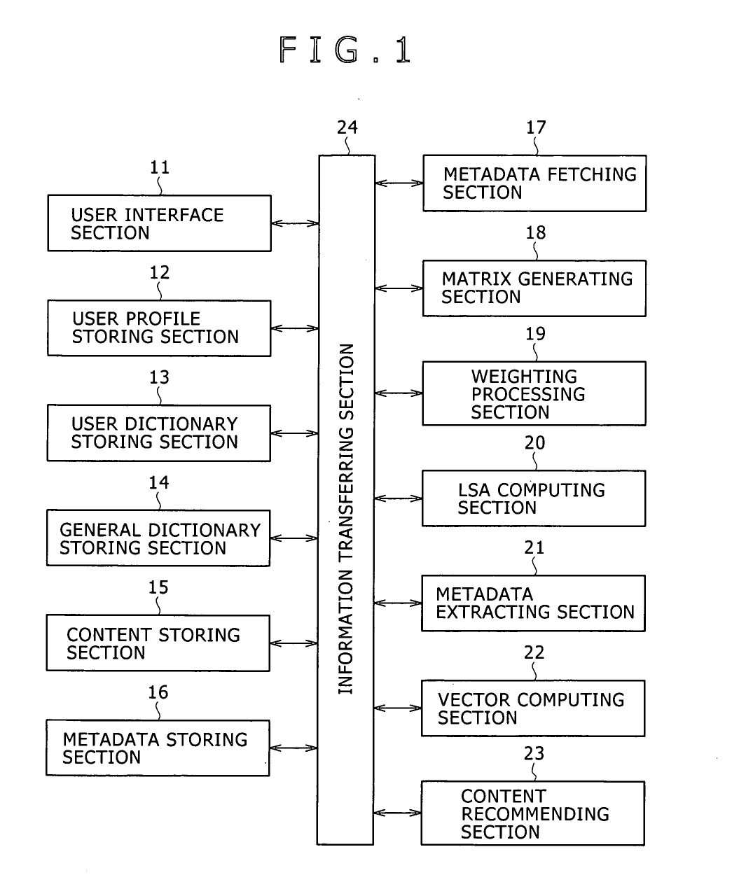

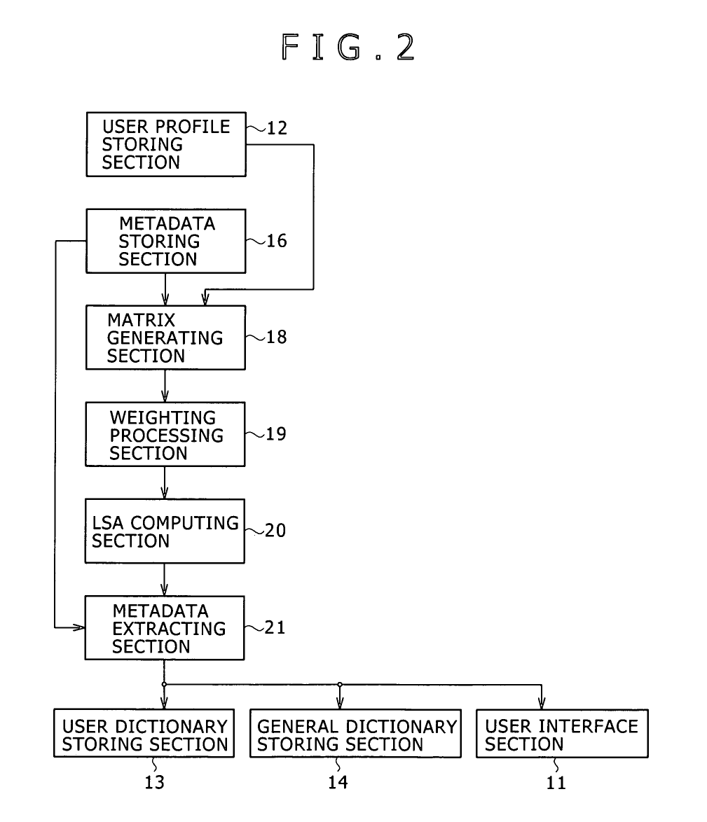

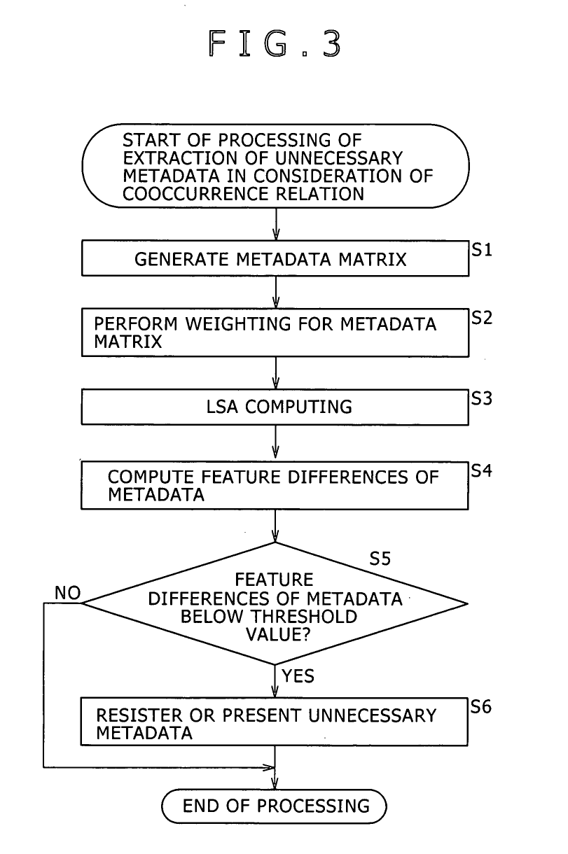

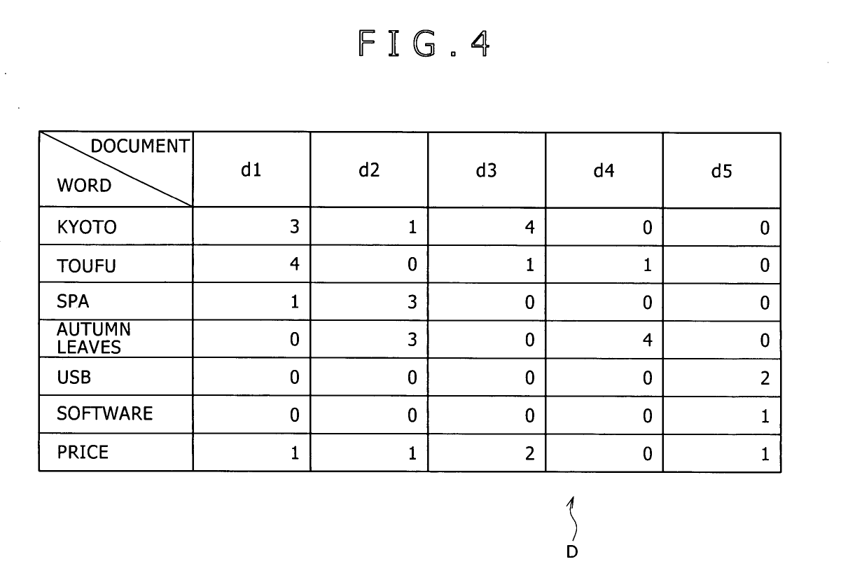

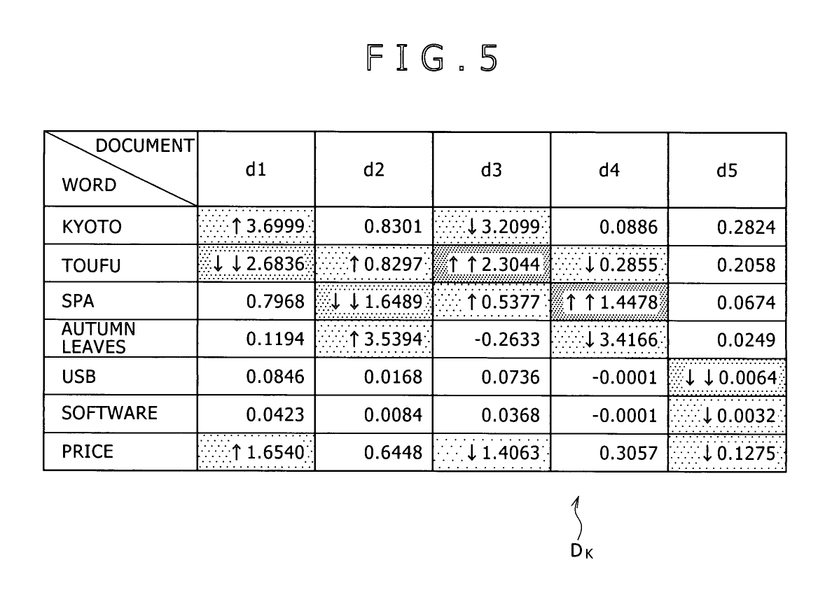

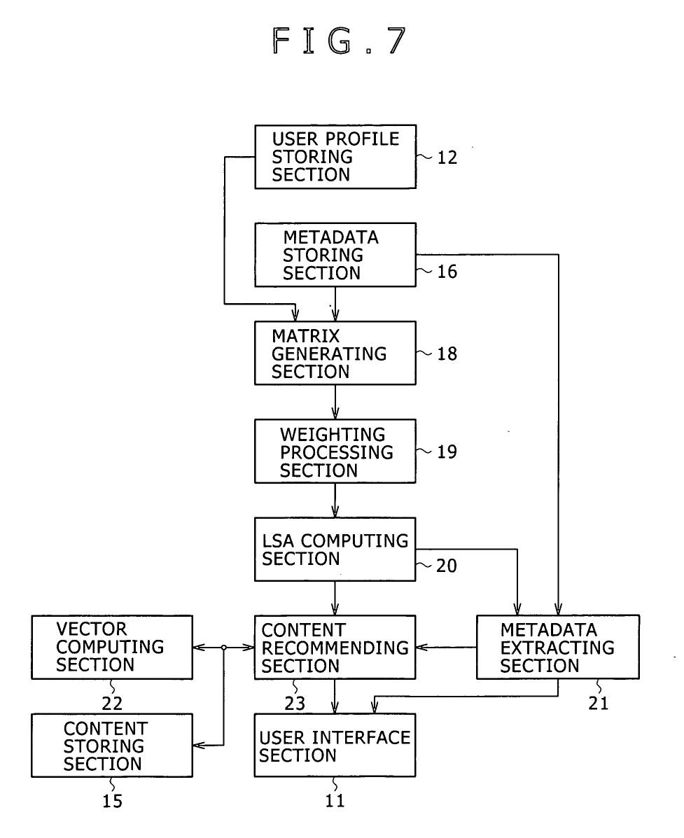

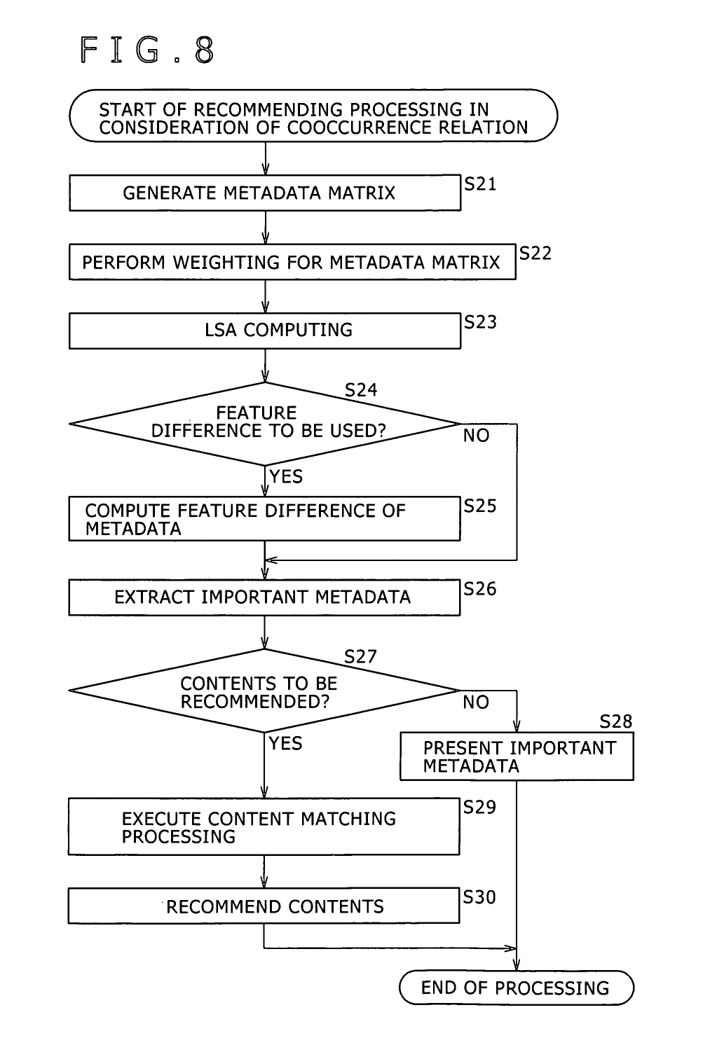

The present invention provides an information processing apparatus. The information processing apparatus (an information processing apparatus illustrated in FIG. 1 and described later in first and second embodiments), includes a matrix generating unit, an approximated matrix generating unit, an index value computing unit, and an extracting unit. Here, the matrix generating unit is, for instance, a matrix generating section 18 in FIG. 1 (FIG. 2 or FIG. 7) for vectorizing each of M (integral value of 1 or more) contents (for instance, notes d1 to d5 in FIG. 4) among a plurality of contents referring to N (integral value of 1 or more) metadata (for instance, each work in FIG. 4, more specifically, for instance, “Kyoto”, “tofu”, “spa”, “autumnal leaves”, “USB”, “software”) correlated to at least one of the plurality of contents and generating a matrix (for instance, a matrix D in FIG. 4) including M vectors obtained as a result of vectorization as column components or row components as a metadata matrix. The approximated matrix generating unit is, for instance, a LSA computing section 20 in FIG. 1 (FIG. 2 or FIG. 7) for generating an approximated matrix (for instance, the approximated matrix Dₖ in FIG. 5) of the metadata matrix by subjecting the metadata matrix generated by the matrix generating unit to singular value decomposition. The index value computing unit is, for instance, a section for executing step S4 in FIG. 3 or step S25 in FIG. 8 among a metadata extracting section 21 in FIG. 1 (FIG. 2 or FIG. 7) for computing an index value indicating importance of metadata corresponding to each of the N metadata based on a difference between the metadata matrix generated by the matrix generating unit and the approximated matrix generated by the approximated matrix generating unit. The extracting unit is, for instance, a section for executing step S5 and S6 in FIG. 3 or step S26 in FIG. 8 among the metadata extracting section 21 in FIG. 1 (FIG. 2 or FIG. 7) for extracting at least one from the N metadata as important metadata having high importance or unnecessary metadata having low importance based on the N index values computed by the index value computing unit.

The information processing apparatus according to the present invention may further include a recommending unit and a presenting unit. Here, the recommending unit is, for instance, a content recommending section 23 in FIG. 1 (FIG. 2 or FIG. 7) for deciding one or more contents to be recommended to a user from among a plurality of contents making use of the important metadata extracted from the N metadata by the extracting unit or metadata excluding unnecessary data extracted by the extracting unit. The presenting unit is, for instance, a user interface section 11 in FIG. 1 (FIG. 2 or FIG. 7) according to step S30 in FIG. 8 for presenting the contents decided by the recommending unit as those to be recommended to the user.

The information processing apparatus according to the present invention may further include a presenting unit (for instance, the user interface section 11 in FIG. 1 (FIG. 2 or FIG. 7) according to step S28 in FIG. 8) for presenting the important metadata or unnecessary metadata extracted by the extracting unit to the user.

The information processing apparatus according to the present invention may further include a storing unit (for instance, a user dictionary storing section 13 or a general dictionary storing section 14 in FIG. 1 (FIG. 2)) for storing the important metadata or unnecessary metadata extracted by the extracting unit.

The present invention provides an information processing method. The information processing method (for instance, a method corresponding to “unnecessary metadata extracting processing in consideration of coocurrence relation” in FIG. 3 or “recommending processing in consideration of cooccurrence relation” in FIG. 8) according to the present invention includes a matrix generating step, an approximated matrix generating step, an index value computing step, and an extracting step. Here, the matrix generating step is, for instance, step S1 (S2 may be included) in FIG. 3 or step S21 (S22 may be included) in FIG. 8, for vectorizing each of M (integral value of 1 or more) contents among a plurality of contents based on N (integral value of 1 or more) metadata correlated to at least one of the plurality of contents, and generating a matrix including M vectors obtained as a result of vectorization as column components or row components as a metadata matrix. The approximated matrix generating step is, for instance, step S3 in FIG. 3 or step S23 in FIG. 8 for generating an approximated matrix of the metadata matrix by subjecting the metadata matrix generated in the matrix generating step to singular value decomposition. The index value computing step is, for instance, step S4 in FIG. 3 or step S25 in FIG. 8 for computing an index value indicating importance of corresponding metadata for each of the N metadata based on a difference between the metadata matrix generated in the matrix generating step and the approximated matrix generated in the approximated matrix generating step. The extracting step is, for instance, step S5 and S6 in FIG. 3 or step S26 in FIG. 8 for extracting at least one from the N metadata as important metadata having high importance or unnecessary metadata having low importance based on the N index values computed in the index value computing step.

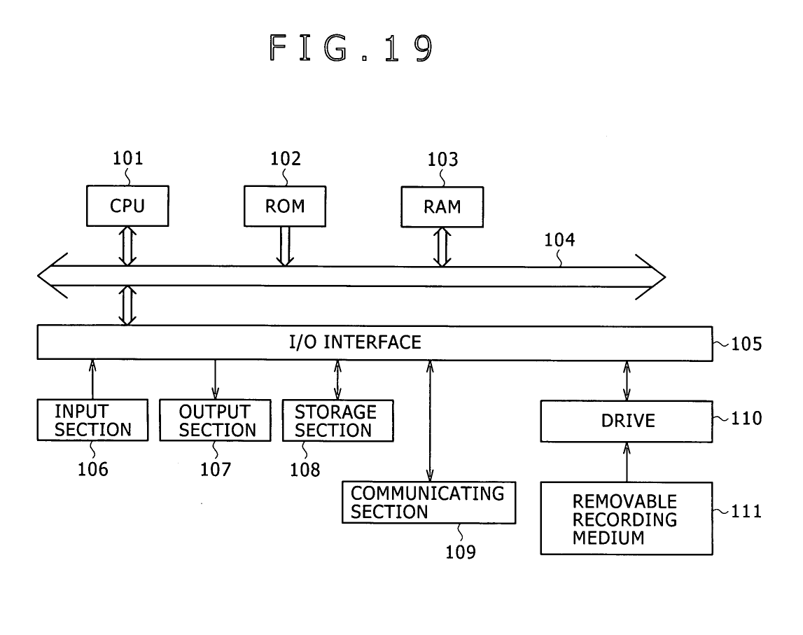

The present invention provides a program. The program is correlated to the information processing method according to the present invention as described above, and executed, for instance, by a computer illustrated in FIG. 19.

As described above, according to the present invention, contents and metadata thereof are processed.

It should be noted herein that the contents and metadata according to the present invention, namely the contents and metadata that can be processed by the present invention, fall into a broader concept compared to the generally-called contents and metadata.

Namely, the contents according to the present invention has a broad concept including not only television broadcast programs, movies, photographs, music and the like generally referred to as contents (animated image, still image, or sound, or combination thereof), but also all of software and hardware usable for a user such as documents, merchandise (including goods), conversation, and the like. However, in the case where the contents is goods (hardware), for instance, data produced by projecting the goods into an animated image or a still image is used as the content data.

When it is not necessary to distinguish between contents and content data, the contents and content data are collectively referred to herein as contents.

Metadata according to the present invention indicates the following information. Namely, the contents according to the present invention includes, as described above, not only general contents but also a user's private documents (for instance, emails) and the like. Therefore, the metadata according to the present invention has a broad concept including not only general metadata such as broadcast program metadata but also a whole or a part of the contents according to the present invention (contents by broad concept), or information expressed with words consisting of attributes and the like of the contents (numeric value is also regarded as a unit of information expressed with words). In other words, all of any information indicating one or more features of the contents according to the present invention may be the metadata.

More specifically, for instance, the contents may include web pages, emails, internet bulletin board, books and the like, in addition to the television broadcast programs, movies, and music as described above.

In this case, for instance, broadcast time, performer, staff, genre, channel and the like may be cited as types of television broadcast program metadata. As types of movie metadata, for instance, screen time, performer, staff, genre, film distributor and the like may be cited. As types of music metadata, for instance, an artist name, genre, instrument, rhythm, atmosphere, and the like may be cited. As types of web page metadata, for instance, a web site designer, outbound link, inbound link, URL (region and the like), written words and the like may be cited. As types of email metadata, sender/receiver, transmitted date and time, written words and the like may be cited. As types of internet bulletin board metadata, a writer, written date and time, written words and the like may be cited. As types of book metadata, an author, publisher, published date and time, written words and the like may be cited.

Next, with reference to drawings, there is described an embodiment of the information processing system incorporating the present invention capable of treating the contents and metadata in the broad concept as described above.

FIG. 1 shows an example of functional configuration of the information processing system incorporating the present invention.

As shown in FIG. 1, the information processing system is equipped with a user interface section 11 to an information transferring section 24.

The user interface section 11 is configured with an output device enabling a user to experience the contents thereby and an input device enabling the user to operate the contents. More specifically, for instance, the output device may be a display, a speaker, and the like. The input device may be a keyboard, a mouse, a remote controller, a touch panel, and the like.

A user profile storing section 12 stores information such as pointers (ID number and the like) to contents that the user has experienced in the past, evaluation of the same, and the like. The evaluation is what has been inputted by the user using the user interface section 11.

Therefore, other blocks are capable of reading desired contents out of a content storing section 15 and reading metadata related thereto out of a metadata storing section 16, by referring to various information stored in the user profile storing section 12.

A user dictionary storing section 13 stores frequently used metadata, important metadata, unnecessary metadata and the like among the metadata of contents experienced by the user. The important metadata and unnecessary metadata will be detailed later. The user dictionary storing section 13 may also store weight of the metadata specific to the user. In the user dictionary storing section 13, data can be transferred to and from the user interface section 11, a content recommending section 23, a metadata extracting section 21 and the like, and any action of addition, deletion, and reference of any number of any data can be freely executed.

The general dictionary storing section 14 stores metadata common to users. For instance, all of appeared metadata may be stored in the general dictionary storing section 14, and important metadata and unnecessary metadata common to all users may be stored in the general dictionary storing section 14. The general dictionary storing section 14 may also store the weight of the user-common metadata. In the general dictionary storing section 14 also, data can be transferred to and from the user interface section 11, the content recommending section 23, the metadata extracting section 21 and the like, and any action of addition, deletion, and reference of any number of any data can be freely executed.

The content storing section 15 stores contents available to users, namely, for instance, images, music, writings, world wide web, and the like. The main function of the content storing section 15 is a function to provide the content recommending section 23 with data in response to a request from the content recommending section 23. Each of the contents stored in the content storing section 15 has an identifier such as an ID number assigned thereto. Also, in the content storing section 15, any action of addition, deletion, and reference of any number of any data can be freely executed.

The metadata storing section 16 stores metadata correlated to the contents stored in the content storing section 15. Storing metadata does not mean simply storing the metadata therein, but has a broader concept of storing frequency and heuristically determined weight of each metadata in the contents respectively, to each of which identifiable by an identifier such as the ID number as described above any number of metadata is correlated.

Each of the sections, the user profile storing section 12 to metadata storing section 16, described above is configured as a region in a memory such as a hard disk.

On the contrary, each of sections, a metadata fetching section 17 described below to the content recommending section 23, may be configured as software, hardware, or a combination thereof, if configurable in such a way.

The metadata fetching section 17 fetches the metadata to be stored in the metadata storing section 16 described above and stores the same in the metadata storing section 16. For instance, in a case where the content is writing, the metadata fetching section 17 extracts, for instance, words used in the writing, analyzes frequency of appearance of the word and the like, and correlates each of the words to the frequency of appearance thereof to store the information in the metadata storing section 16.

The matrix generating section 18 accumulates the above-described content vectors indicating a plurality of contents respectively, and generates a metadata matrix having each content vector as, for instance, a column component. In the matrix generating section 18, such a process as weighting is not executed.

A weighting processing section 19 weights a metadata matrix generated by the matrix generating section 18 by various algorithms such as TF/IDF. The timing of weighting process by the weighting processing section 19 is not limited but may be before or after an LSA computing process by an LSA computing section 20 described below.

The LSA computing section 20 executes LSA computing for the metadata matrix generated by the matrix generating section 18 or for the metadata matrix with each component weighted by the weighting processing section 19. The LSA computing as used herein refers to the first to third processing described hereinafter.

In the first processing, singular value decomposition is executed.

In the second processing, a projection matrix is generated by using a result of the first processing, and each column component in the metadata matrix, namely each content vector (group) is projected into a conceptual space via the projection matrix.

In the third processing, an approximated matrix of the metadata matrix is generated by using a result of the second processing. Namely, the third processing is processing for generating a approximated matrix of which dimension is appropriately compressed for the metadata matrix.

The LSA computing is described in more detail hereinafter.

For instance, suppose a metadata matrix D with N rows and M columns is provided to the LSA computing section 20 from the matrix generating section 18 or from the weighting processing section 19.

In this case, as the first processing, the LSA computing section 20 executes singular value decomposition to the metadata matrix D with N rows and M columns to decompose the metadata matrix D into respective component matrixes U, Σ, and V, which satisfy the equation (1) below. In the equation (1), the component matrix U represents a left singular vector with N rows and N columns, the component matrix V represents a right singular vector with M rows and M columns, and the component matrix E represents a singular matrix with N rows and M columns respectively. VT represents a transposed matrix of the component matrix V.
D=UΣV^{T} (1)

Assuming that the rank of the metadata matrix D is r (integral value of N, M or more), the component matrix E has r elements in singular value arrayed on the diagonal line, while the other elements are all zero in the matrix. Further, since column components of r columns arrayed first in the component matrix U (left singular vectors) are orthonormal bases, and more important column components are successively arrayed from the left, the best approximation can be formed by using k left singular vectors (k is an integral value less than r) to express (project) each content vector.

Then, as a step of the second processing, LSA computing section 20 generates a projection matrix (hereinafter referred to as Uₖ) consisting of column components of k columns from the top of the component matrix U (left singular vectors), namely a projection matrix Uₖ with N rows and k columns.

Next, as another of the second processing, LSA computing section 20 multiplies respective column components in the metadata matrix D, namely respective content vectors (N-dimension), by the transposed matrix of this projection matrix Uₖ from the left side, to generate respective content vectors dimensionally reduced to k-dimension (respective approximated vectors of respective corresponding content vectors). Namely, the LSA computing section 20 projects each content vector into a conceptual space with k-dimension. In other words, the LSA computing section 20 generates a conceptual space by generating a projection matrix Uₖ in the first processing.

Also as another step of the third processing, with the use of the right singular vectors for the component matrix V, LSA computing section 20 generates a matrix (hereinafter referred to as Vₖ) consisting of column components of k columns from the top of the component matrix V (right singular vectors), namely a matrix Vₖ with M rows and k columns.

Further as still another step of the third processing, the LSA computing section 20 generates a matrix (hereinafter referred to as Σₖ) consisting of elements in rows from the first to k-th rows among column components of k columns from the top of the component matrix Σ (upper left components consisting of k by K elements among the component matrix Σ), namely a matrix Σₖ with k rows and k columns.

Then as still another of the third processing, the LSA computing section 20 computes the right side of a equation (2) below to generate an approximated matrix Dₖ with a rank reduced to k. In the equation (2), Vₖ^{T} represents a transposed matrix of the component matrix Vₖ.
Dₖ=UₖΣₖVₖ^{T} (2)

The LSA computing is executed by the LSA computing section 20 as described above.

The metadata extracting section 21 executes prespecified computing for respective component values of the metadata matrix D with respective components weighted by the weighting processing section 19, or for respective component values of the approximated matrix Dₖ generated via LSA computing by the LSA computing section 20, and extracts characteristic metadata based on the computing results. In addition, the metadata extracting section 21 notifies such as identification numbers of the extracted metadata to other blocks as required.

The vector computing section 22 executes processing for computing similarity between vectors as expressed by the cosine function (matching processing) and/or clustering processing for classifying into a plurality of groups, by using content vector groups appropriately processed by the weighting processing section 19 or the LSA computing section 20, namely using an aggregation of one or more column components among the metadata matrix D or the approximated matrix Dₖ. Control of these processing is performed by the content recommending section 23.

The content recommending section 23 executes processing for requesting appropriate processing (matching processing and/or clustering processing as described above) to the vector computing section 22, processing for reading prespecified contents from the content storing section 15, processing for presenting contents to a user via the user interface section 11, by using the metadata matrix D with respective components weighted by the weighting processing section 19 or the approximated matrix Dk generated via LSA computing by the LSA computing section 20.

The information transferring section 24 transfers various information sent from prespecified blocks among sections from the user interface section 11 to the content recommending section 23, to appropriate blocks among sections from the user interface section 11 to the content recommending section 23.

The information processing system according to the present invention was described above with reference to FIG. 1.

In a case, for instance, where the information processing system according to the present invention consists of clients and a server, the user interface section 11 in FIG. 1 is arranged on each client, while each one of the others from the user profile storing section 12 to the content recommending section 23 may be arranged either on the server side or the client side.

Specifically, for instance, it is possible to arrange the user interface section 11, the user profile storing section 12 related to a user's privacy, and the user dictionary storing section 13 onto the client side, while arranging the other sections from the general dictionary storing section 14 to the content recommending section 23 onto the server side.

Alternatively, for instance, it is possible to arrange the content storing section 15 and the metadata storing section 16, both of which require a mass storage capacity, onto the sever side, while arranging the other blocks, namely sections from the user interface section 11 to the general dictionary storing section 14 and sections from the metadata fetching section 17 to the content recommending section 23, onto the client side.

Alternatively, for instance, it is possible to arrange sections from the user interface section 11 to the content recommending section 23 respectively onto the server side and the client side to be appropriately distributed in order to split computing load.

In this case, namely, where the information processing system according to the present invention consists of clients and a server for instance, the information transferring section 24 includes communication devices for communicating other information processing apparatus via a network, and these communication devices are provided in the server and the clients respectively. Namely, the server and the clients communicate one another via a network by respectively using integrated communication devices.

Further in this case, the information transferring section 24 may include various kinds of buses respectively provided inside the server and the clients. Namely, when at least two blocks among sections from the user interface section 11 to the content recommending section 23 are arranged in a client, information exchange between these blocks is carried out via the various kinds of buses in the client. Similarly, when at least two blocks among sections from the user profile storing section 12 to the content recommending section 23 are arranged in the server, information exchange between these blocks is carried out via the various kinds of buses in the sever.

For another instance, the all sections from the user interface section 11 to the content recommending section 23 can be arranged on the client side. Namely, the all sections from the user interface section 11 to the content recommending section 23 may be arranged in one unit for information processing. In this case, the information transferring section 24 is composed of, for instance, various kinds of buses provided inside the information processing apparatus.

The information processing system in FIG. 1 having such configuration, as described above, can vectorizes each of M (integral value of 1 or more) contents among a plurality of contents referring to N (integral value of 1 or more) metadata correlated to at least one of the plurality of contents, and generates a matrix including M vectors obtained as a result of vectorization as column components or row components as a metadata matrix D. In addition, the information processing system in FIG. 1 can perform weighting and LSA computing to the metadata. In this way, the metadata matrix D appropriately weighted and its approximated matrix Dₖ can be obtained.

Therefore, the information processing system in FIG. 1 can perform various processing using the metadata matrix D appropriately weighted and its approximated matrix Dₖ. For instance, the information processing system in FIG. 1 can execute conventional content recommendation processing described above as a matter of course, and moreover it can execute processing invented by the applicant, such as the following first to fifth processing.

In other words, the applicant has newly invented an information processing system or an information processing apparatus capable to execute each of the following first to fifth processing. The applicant has disclosed the information processing system with configuration in FIG. 1 as an embodiment of the invention. Therefore, it is needless to say that its form is not limited to the example in FIG. 1 as long as it is an information processing system or an information processing apparatus capable to execute each of the following first to fifth processing.

The first processing means “unnecessary metadata extracting processing in consideration of consideration cooccurrence relation”. The second processing means “recommending processing in consideration of cooccurrence relation”. The third processing means “recommending processing using differences among clustered UPV (user preference vector) groups”. The fourth processing means “re-evaluating processing for contents by LSA”. The fifth processing means “recommending processing with a hybrid of LSA and other technique”.

Hereinafter, details of the first to the fifth processing are individually described in this order. Namely, hereinafter, embodiments of an information processing system or an information processing apparatus for executing each of the first to fifth processing are individually described in this order. It is to be noted that, for the purpose to simplify descriptions in the following, respective embodiments of an information processing system or an information processing apparatus for executing respective processing of the first to fifth processing are hereinafter referred to as a first embodiment to a fifth embodiment respectively.

### First Embodiment

Firstly, a first embodiment is described below.

For instance, when the content is a text, a frequency of a word appearing in the text (or a properly weighted value corresponding to the frequency) may be employed as metadata for the word.

In this case, when a new document is added as a new object for processing, among words appearing in the new text, new words not having appeared in the existing documents are added as base vectors for new metadata to the metadata space.

Namely, the number of dimensions in metadata is equalized to the number of types of words appearing in all texts regarded as objects for processing. Therefore, as the number of texts having been regarded as objects for processing increases, namely as the number of texts prepared or accessed to look by a user increases, also the number of dimensions in metadata space increases. More specifically, the number of dimensions in metadata space generally increases up to several thousands or several tens of thousands.

As a result, computing such as matching processing or clustering processing in the subsequent steps may sometimes become difficult disadvantageously. Also in the conventional technology, it has been tried to reduce the number of words based on a weight of each word to overcome the problems as described above, but when such a technique as the TF/IDF is used, cooccurrence (or synonymity) of the metadata (or words) is not taken into consideration, and sometimes words not to be deleted may often be deleted, which is disadvantageous.

For solving the problems as described above, the present inventor invented the first processing described above, namely the “processing for extraction of unnecessary metadata in consideration of cooccurrence relation”.

In this first processing, an approximated matrix Dₖ generated by LSA is used. The approximated matrix Dₖ is a matrix generated by in consideration of the cooccurrence relation. However, the relativity between the approximated matrix Dₖ and the cooccurrence relation is described hereinafter.

Descriptions are provided below for the information processing system or information processing apparatus according to a first embodiment of the present invention, namely the information processing system or information processing apparatus for executing the “processing for extraction of unnecessary metadata in consideration of cooccurrence relation” is described below with reference to FIG. 2 to FIG. 6.

FIG. 2 shows an example of functional configuration of the information processing system or information processing apparatus according to a first embodiment of the present invention.

In other words, blocks required for execution of the “processing for extraction of unnecessary metadata in consideration of cooccurrence relation” are extracted from all blocks in the user interface section 11 through the content recommending section 23 shown in FIG. 1, and the FIG. 2 is a view showing the situation in which the blocks are arrayed according to a flow of information when the “processing for extraction of unnecessary metadata in consideration of cooccurrence relation” is executed. The blocks are described above with reference to FIG. 1 above, and descriptions thereof are omitted herefrom.

Although not shown in FIG. 2, actually within each arrow mark connecting two blocks, namely between the two blocks, the information transfer section 24 shown in FIG. 1 is provided.

FIG. 3 is a flow chart for illustrating an example of the “processing for extraction of unnecessary metadata in consideration of cooccurrence relation”. An example of the “processing for extraction of unnecessary metadata in consideration of cooccurrence relation” is described below with reference to the flow chart shown in FIG. 3.

For making it easier to understand the “processing for extraction of unnecessary metadata in consideration of cooccurrence relation”, descriptions are provided below with reference to FIG. 4 to FIG. 6 according to the necessity. Namely FIG. 4 to FIG. 6 show specific examples of the processing result of the “processing for extraction of unnecessary metadata in consideration of cooccurrence relation”.

In step S1 shown in FIG. 3, the matrix generating section 18 generates a metadata matrix D.

More specifically, in step S1, the matrix generating section 18 fetches pointers (ID numbers or the like) for one or more contents which a user already experienced from the user profile storing section 12. Then the matrix generating section 18 fetches metadata each with a pointer assigned thereto, namely metadata corresponding to contents which the user already experienced from the metadata storing section 16, and vectorizes each of the contents which the user has already experienced based on the fetched metadata as base vectors. With this operation, content vectors corresponding to contents which the user already experienced are generated. Then the matrix generating section 18 generates a metadata matrix D including the content vectors as the column components.

The metadata accumulated as a result of the processing in step 1 may be, in addition to the metadata corresponding to the contents which the user already experienced, those corresponding to all contents, or those corresponding to contents which a plurality of users already experienced. A destination for registration of unnecessary metadata in step S6 described hereinafter varies according to contents as objects for the metadata fetching processing.

In step S2, the weighting processing section 19 performs weighting to the metadata matrix D generated by the matrix generating section 18 in the processing in step S1 making use of a prespecified weighting technique.

There is not specific restriction over the weighting technique employed in the processing in step S2, and various techniques including the technique using the TF/IDF, a technique using normalized TF, or a technique in which heuristic weighting reflecting, for instance, passage of time is performed for each contents or metadata may be employed.

The following descriptions assume a case in which five texts d1 to d5 as contents are objects for processing, words appearing in the texts d1 to d5 are employed as metadata, and a technique using a frequency of appearance of each word in the texts as it is as a weight value is employed as the weighting technique.

More specifically, it is assumed, for instance, that frequencies of appearance of the words “Kyoto”, “toufu”, “spa”, “autumn leaves”, “USB”, “software”, and “price” in the text d1 are 3, 4, 1, 0, 0, 0, and 1 respectively, and also that frequencies of appearance of the words “Kyoto”, “toufu”, “spa”, “autumn leaves”, “USB”, “software”, and “price” in the text d2 are 1, 0, 3, 3, 0, 0, 1 respectively. Further it is assumed that frequencies of appearance of the words “Kyoto”, “toufu”, “spa”, “autumn leaves”, “USB”, “software”, and “price” in the text d3 are 4, 1, 0, 0, 0, 0, and 2 respectively. Still further it is assumed that frequencies of appearance of the words “Kyoto”, “toufu”, “spa”, “autumn leaves”, “USB”, “software”, and “price” in the text d4 are 0, 1, 0, 4, 0, 0, and 0 respectively. In addition it is assumed that frequencies of appearance of the words “Kyoto”, “toufu”, “spa”, “autumn leaves”, “USB”, “software”, and “price” in the text d5 are 0, 0, 0, 0, 2, 1, and 1 respectively.

In this case, as a result of processing in step S2, the weighted metadata matrix D as shown in FIG. 4 is generated. Namely, as a result of processing in step S2, the metadata matrix D with seven rows and five columns including content vectors in the texts d1 to d5 (content vectors weighted according to the frequency, which are so-called feature vectors), is generated.

The content vectors in the text d1 (“Kyoto”, “toufu”, “spa”, “autumn leaves”, “USB”, “software” and “price”) are (3, 4, 1, 0, 0, 0, 1). The content vectors in the documents d2 are (1, 0, 3, 3, 0, 0, 1). The content vectors in the text d3 are (4, 1, 0, 0, 0, 0, 2). The content vectors in the text d4 are (0, 1, 0, 4, 0, 0, 0). The content vectors in the text d5 are (0, 0, 0, 0, 2, 1, 1).

Again in step S3 in FIG. 3, the LSA computing section 20 executes LSA computing to the metadata matrix D properly weighted by the weighting processing section 19 in the processing in step 2.

In the processing in step 3, the first processing and third processing in the LSA computing are executed, and as a result, the approximated matrix Dₖ having been subjected to proper dimensional compression is generated.

More specifically in this case, when the processing in step S3 is executed to the matrix D shown in FIG. 4, for instance the approximated matrix Dₖ compressed to two dimensions as shown in FIG. 5 is generated.

Namely, as a result of the processing in step S3, the approximated matrix Dₖ having seven rows and five columns and including respective content vectors for the texts d1 to d5 updated as described below as column components in the first to fifth columns is generated.

Namely the updated content vectors for the text d1 are (3.6999, 2.6836, 0.7968, 0.1194, 0.0846, 0.0423, 1.6540). The updated content vectors for the text d2 are (0.8301, 0.8297, 1.6489, 3.5394, 0.0168, 0.0084, 0.6448). The updated content vectors for the text d3 are (3.2099, 2.3044, 0.5377, −0.2633, 0.0736, 0.0368, 1.4063). The updated content vectors for the text d4 are (0.0886, 0.2855, 1.4478, 3.4166, −0.0001, −0.0001, 0.3057). The updated content vectors for the text d5 are (0.2824, 0.2058, 0.0674, 0.0249, 0.0064, 0.0032, 0.1275).

Again referring to FIG. 3, the metadata extracting section 21 computes, in step S4, feature differences of the metadata using the approximated matrix Dₖ computed by the LSA computing section 20 in the processing in step S3.

The feature difference indicates an index value for importance of metadata generated by making use of a difference (change) between the metadata matrix D and the approximated matrix Dₖ.

More detailed descriptions are provided for this feature difference below.

For instance, in the approximated matrix Dₖ shown in FIG. 5, the two upward arrows looking like (↑↑) indicate a component with the weight value (component value) increased by 1 or more as compared to that in the metadata matrix D shown in FIG. 4. Similarly, the one arrow looking like (↑) indicates a component with the weight value increased by 0.5 or more as compared to that in the metadata matrix D shown in FIG. 4.

The meaning that a component in the approximated matrix Dₖ increases as compared to that in the metadata matrix D is as described below.

Namely, there is a case in which, although importance of prespecified metadata in prespecified contents is originally high, the importance is regarded low in the metadata matrix D generated not in consideration of cooccurrence relation of metadata extending over a plurality of contents, and as a result, the corresponding component value in the metadata matrix D is set to a low value.

In this case, when the approximated matrix Dₖ is generated, the originally high importance in the metadata in the contents is clearly shown, and the corresponding component value in the approximated matrix Dₖ is changed to a high value.

This is because the approximated matrix Dₖ is a matrix obtained by deleting base components regarded as not important as main components in a conceptual space (those having low singular values) and computing the reduced contents again. In other words, the approximated matrix Dₖ is a matrix in which the components are updated in consideration of cooccurrence relation of metadata extending over a plurality of contents.

The meaning that a component value in the approximated matrix Dₖ increases as compared to that in the metadata matrix D is as described below.

For instance, in the example of the approximated matrix Dₖ shown in FIG. 5, the two arrows looking like (↓↓) indicates a component with the weight value reduced by 1 or more as compared to that in the metadata matrix D shown in FIG. 4. Similarly, the one arrow looking like (↓) indicates a component with the weight value reduced by 0.5 or more as compared to that in the metadata matrix D shown in FIG. 4.

The meaning that a component in the approximated matrix Dₖ decreases as compared to that in the metadata matrix D is as described below.

Namely, there is a case in which, although importance of prespecified metadata in prespecified contents is originally low, the importance is regarded high in the metadata matrix D generated not in consideration of cooccurrence relation of metadata extending over a plurality of contents, and as a result, the corresponding component value in the metadata matrix D is set to a high value.

In this case, when the approximated matrix Dₖ is generated, the originally low importance in the metadata in the contents is clearly shown, and thus the corresponding component value in the approximated matrix Dₖ is changed to a low value.

The meaning that a component value in the approximated matrix Dₖ decreases as compared to that in the metadata matrix D is as described above.

As described above, it may be said that a difference (change) between the metadata matrix D and approximated matrix Dₖ expresses a difference in interpretation of importance of metadata before and after cooccurrence of metadata extending over a plurality of metadata is taken into consideration.

Therefore, by making use of the difference (change) between the metadata matrix D and approximated matrix Dₖ, an index value for importance of metadata, namely a feature difference of metadata can be computed.

In other words, there is no specific restriction over the technique for computing a feature difference of metadata so long as a difference (change) between the metadata matrix D and approximated matrix Dₖ is taken into consideration, and various techniques may be employed for the purpose.

For instance, a feature difference of metadata can be computed by any of the first to third feature difference computing techniques described above.

In the first feature difference computing technique, a feature difference is computed by making use of a component value itself in the approximated matrix Dₖ. Use of a component value itself in the approximated matrix Dₖ may be also regarded as use of a difference (change) between the metadata matrix D and approximated matrix Dₖ.

More specifically, one piece of metadata corresponds to one row in each of the metadata matrix D and approximated matrix Dₖ. For instance, in the examples of the metadata matrix D shown in FIG. 4 and approximated matrix Dₖ shown in FIG. 5, the metadata (word) of “Kyoto” corresponds to the first row. Namely, each of component value in one row indicates a weight value for the corresponding metadata in the row for each of the contents (texts). For instance, in the examples of the metadata matrix D shown in FIG. 4 and approximated matrix Dₖ shown in FIG. 5, each of the component values in the first row indicates each of weight values for metadata (word) of “Kyoto” in the texts d1 to d5.

Therefore, for instance, when a metadata matrix D is generated from N metadata and M content data, namely when the metadata matrix D includes N rows and M columns, the N metadata are successively set as metadata to be remarked as objects for processing one by one (described as remarked metadata hereinafter), an average value for or a maximum value among M component values in a row indicating remarked metadata is computed, namely an average value for or a maximum value among weight values for M contents relating to remarked metadata is computed, and a result of the computing above is regarded as a feature difference for the remarked data. This technique is one example of the first feature difference computing technique.

In the second feature difference computing technique, a feature difference is computed by making use of a difference value between each of the component values in the approximated matrix Dₖ and each of the corresponding component values in the metadata matrix D.

More specifically, for instance, when the metadata matrix D has N rows and M columns, N metadata are successively set as remarked metadata, a difference value between each of the M component values in a row indicating remarked metadata in the approximated matrix Dₖ and each of the corresponding components in the metadata matrix D is computed, an average value for or a maximum value among the computed M difference values is computed, and a result of the computing is regarded as a feature difference for the remarked metadata. This is an example of the second feature difference computing technique.

When a component value increases as a result of LSA computing, namely when the component value in the metadata matrix D is larger than the corresponding value in the approximated matrix Dₖ, a difference value for the component between the approximated matrix Dₖ and the metadata matrix D is naturally a positive value.

When the matter described above and the meaning of increase of a component value as a result of LSA computing are taken into consideration, a positive value of a feature difference of remarked metadata computed by the second feature difference computing technique is equivalent to a result of determination in consideration of cooccurrence relation of metadata extending over a plurality of contents that the remarked metadata is important. To describe more accurately, a positive value of a feature difference value is equivalent to the fact that the original high importance of the remarked metadata is clearly shown.

A negative value of a feature difference of remarked metadata computed by the second feature difference computing technique is, for the same reason applicable to a case of a positive value of a feature difference but viewed from the other side, equivalent to a result of determination in consideration of cooccurrence relation of metadata extending over a plurality of contents that the importance is low. More accurately, a negative value of a feature difference is equivalent to the fact that the original low importance of remarked metadata is clearly shown.

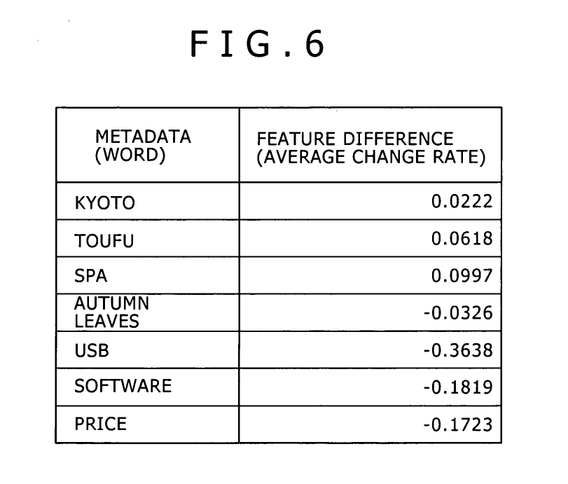

More specifically, for instance, FIG. 6 shows a result of computing for a feature difference computed by the second feature difference computing technique using the approximated matrix Dₖ shown in FIG. 5. More accurately, the words of “Kyoto”, “toufu”, “spa”, “autumn leaves”, “USB”, “software”, and “price” are successively set as remarked metadata, and difference values between five components values in a row indicating remarked metadata in the approximated matrix Dₖ shown in FIG. 5, namely between weight values for the remarked metadata in the texts d1 to d5 and corresponding component values in the metadata matrix D shown in FIG. 4 are computed, and an average value of these five feature difference values is computed as a feature difference. The result of the computing is as shown in FIG. 6.

To describe in further detail, a feature difference for “Kyoto” is 0.0222. Feature differences for “toufu”, “spa”, “autumn leaves”, “USB”, “software”, and “price” are 0.0618, 0.0997, −0.326, −0.3638, −0.1819, and −0.1723 respectively.

Therefore, it may be said that the words “Kyoto”, “toufu”, and “spa” have been determined as important as a result of determination in consideration of cooccurrence relation of words extending over the texts d1 to d5, or more accurately that the importance, which each of the words originally has, is clearly shown.

Further it may be said that the words “autumn leaves”, “USB”, “software” and “price” have been determined as not so important as a result of determination in consideration to cooccurrence relation of words extending in the texts d1 to d5, or more accurately that the low importance, which each of the words originally has, is clearly shown.

More specifically, the following matter is understood from the feature differences for the metadata shown in FIG. 6. Namely, the words of “USB” and “software”, which appear only in the text d5 having low relativity with other documents and are correlated to each other strongly but are not so relevant to other words, are treated as having extremely low importance (the weight is substantially lowered). Further also it is understood that the word such as “price”, which will often appear in any text, is regarded as having low importance (the weight is lowered). In contrast, such words as “spa” and “toufu”, which strongly characterize the document and suggest that there are a plurality of similar documents, are regarded as having high importance (the weight is raised).

The second feature difference computing technique is as described above. Now descriptions are provided for a third feature difference computing technique.

In the third feature difference computing technique, quotients obtained by dividing component values in the approximated matrix Dₖ by corresponding component values in the metadata matrix D are used for computing a feature difference.

More specifically, when a metadata matrix D has N rows and M columns, the N metadata are successively set as remarked metadata successively, and quotients are computed by dividing M component values in a row indicating remarked metadata in the approximated matrix Dₖ by corresponding component values in the metadata matrix D, an average value for or a maximum value among the computed M quotients is computed, and the result of the computing is regarded as a feature difference for the remarked metadata. This is an example of the third feature difference computing technique.

When one component value increases as a result of the LSA computing, namely when one component value in the metadata matrix D is larger than the corresponding component value in the approximated matrix Dₖ, a quotient for the component obtained by dividing the value in the metadata matrix D by the corresponding value in the approximated matrix Dₖ is naturally larger than 1.

The matter described above and the meaning of a component value as a result of LSA computing are taken into consideration, a feature difference value larger than 1 for remarked metadata obtained by the third feature difference computing technique is equivalent to a result of determination in consideration of cooccurrence relation of metadata extending over a plurality of contents that the remarked metadata is important. More accurately, a feature difference value larger than 1 is equivalent to the fact that the original high importance of the remarked metadata is clearly shown.

A value of a feature difference of remarked data smaller than 1 computed by the second feature difference computing technique is, for the same reason applicable to a case of a value of a feature difference larger than 1 but viewed from the other side, equivalent to a result of determination in consideration of cooccurrence relation of metadata extending over a plurality of contents that the importance is low. More accurately, a value of a feature difference smaller than 1 is equivalent to the fact that the original low importance of remarked data is clearly shown.

As examples of techniques for computing a feature difference for metadata in step S4 shown in FIG. 3, the first to third feature difference computing techniques have been described above.

When feature difference values for metadata have been computed in the processing in step S4, the processing flows to step S5.

In step S5, the metadata extracting section 21 determines whether a feature difference for metadata is not more than a threshold value or not.

When all of the feature difference values for the metadata are over the threshold value, a response of NO is provided in step S5, and the processing is terminated.

In contrast, if there is even one feature difference for metadata less than the threshold value, a response of YES is provided in step S5, and the processing flows to step S6.

In step S6, the metadata extracting section 21 registers or presents unnecessary metadata. More precisely, in step S6, the metadata extracting section 21 identifies metadata having feature differences each not larger than a threshold value as unnecessary metadata, and extracts the unnecessary metadata from the metadata storing section 16. Then the metadata extracting section 21 registers (stores) the extracted unnecessary metadata in the user dictionary storing section 13 or the general dictionary storing section 14, or presents the unnecessary metadata via the user interface section 11 to the user. With this operation, the “processing for extracting unnecessary metadata in consideration of cooccurrence relation” is terminated.

As described above, the threshold value used in the processing in step S5 is a value compared to feature difference of metadata to determine whether each metadata should be classified as unnecessary metadata or not. Namely, metadata having feature differences over the threshold value are those having high importance which are not classified as unnecessary metadata. In contrast, metadata having feature differences less than the threshold value are those having low importance, which are classified as unnecessary metadata.

Therefore, the threshold value often varies according to the feature difference computing technique employed in the processing in step S4.

For instance, when the second feature difference computing technique using a difference value as described above is employed, it is advantageous that, for instance, a value less than 0 is used as a threshold value. More specifically, when −0.1 is set as the threshold value in the case shown in FIG. 6, the words “USB”, “software”, and “price” are extracted as unnecessary metadata.

In contrast, for instance, when the third feature difference computing technique using a quotient as described above is employed, it is advantageous that, for instance, a value less than 1 is used as the threshold value.

The information processing system or information processing apparatus according to the first embodiment of the present invention, namely the information processing system or information processing apparatus for executing the “unnecessary metadata extracting processing in consideration of cooccurrence relation” has been described above with reference to FIG. 2 to FIG. 6.

In the first embodiment, weighting in consideration of the relativity (cooccurrence) between metadata in the latent and semantic level is performed by making use of, for instance, the approximated matrix Dₖ or a difference between the approximated matrix Dₖ and the original metadata matrix D. As a result, an index value for importance in consideration of the cooccurrence such as a feature difference can be obtained.

Therefore, by making use of the index value for importance in consideration of the cooccurrence, it is possible to find out metadata apparently looking like non relevant ones or those apparently looking relevant but actually having low relativity and sort the metadata based on the discrimination of metadata as described above.

In other words, it is possible to prevent metadata apparently looking like those not relevant ones but actually having high importance from erroneously being classified as unnecessary metadata. Further it is possible to classify metadata apparently relevant one but actually having low relativity, namely metadata apparently looking important but actually having low importance as unnecessary metadata without fail.

### Second Embodiment

Next, second embodiment of the present invention is described.

In content recommendation based on the prior art, cooccurrence of metadata is not taken into consideration, and simply a weight in the metadata matrix D obtained by TF/IDF, or a weight in an approximated matrix Dₖ obtained by dimensional compression of the metadata matrix D by LSA is used, and therefore only contents similar to known ones (those having been experienced or highly evaluated before by a user) can be recommended, which is disadvantageous.

To solve the problem as described above, the present inventor invented the second processing described above, namely the “processing in consideration of cooccurrence relation”.

In this second processing, the approximated matrix Dₖ generated by LSA or the feature difference of metadata described in the first embodiment is used. As described above, the approximated matrix Dₖ is a matrix generated in consideration of cooccurrence of metadata, and a feature difference for metadata is an index value for the importance in consideration of cooccurrence of metadata.

Outline of the second processing is described below.

The information processing system or information processing apparatus according to the second embodiment (described simply as a device in the description of outline of the second processing) extracts, when remarking some contents, one or more piece of metadata used for recommending contents based on a feature difference or a component value in the approximated matrix Dₖ.

More precisely, as described above, metadata having a large feature difference is that having a not-so large weight in the original metadata matrix D but determined as important when cooccurrence with other metadata is taken into consideration (described as important metadata hereinafter). Therefore it may be considered that the important metadata as used herein is that having high property emergence that a user has not been aware of before.

Therefore the device can extract several metadata, for instance, having large feature differences ranked at upper positions respectively as important data.

Further also the metadata corresponding to large component values in the approximated matrix Dₖ may be regarded as important metadata.

So the device extracts, for instance, metadata corresponding to components in the approximated matrix Dₖ ranked at higher positions as important metadata.

Further the device can extract important metadata based on feature differences, and also can extract important metadata based on component values in the approximated matrix Dₖ. Only the important metadata extracted based on feature differences may be used as one or more important metadata used for content recommendation, or only the important metadata extracted based on component values in the approximated matrix Dₖ may be used. Alternatively, the important metadata extracted based on feature differences and the important metadata extracted based on component values in the approximated matrix Dₖ may be used in combination.

Then the device recommends the one or more important metadata extracted as described above as information available when a user selects contents. Alternatively, the device regards a metadata group consisting of one or more piece of important metadata extracted as described above as one content (column vector), performs matching processing for the metadata group (column vectors) and other contents (column vectors), and recommends other contents based on a result of the matching processing.

Outline of the second processing, namely the “recommending processing in consideration of cooccurrence relation” has been described above.

Next the information processing system or information processing apparatus according to the second embodiment of the present invention, namely the information processing system or information processing apparatus for executing the “recommending processing in consideration of cooccurrence relation” is described hereinafter with reference to FIG. 7 and FIG. 8.

FIG. 7 is a view showing an example of functional configuration of the information processing system or information processing apparatus according to the second embodiment.

In other words, blocks required for execution of the “recommending processing in consideration of cooccurrence relation” are extracted from all blocks in the user interface section 11 to the content recommending section 23 shown in FIG. 1, and FIG. 7 shows the situation in which the blocks are arrayed according to a flow of information when the “recommending processing in consideration of cooccurrence relation” is executed. Each block shown in FIG. 7 has already been described with reference to FIG. 1, and description thereof is omitted here.

Although not shown in FIG. 7, within each arrow connecting two blocks, namely between the two blocks, the information transfer section 24 shown in FIG. 1 is provided.

FIG. 8 is a flow chart for illustrating an example of the “recommending processing in consideration of cooccurrence relation”. Now an example of the “recommending processing in consideration of cooccurrence relation” is described with reference to the flow chart shown in FIG. 8.

Steps 21 to 23 shown in FIG. 8 are basically the same as the steps S1 to S3 shown in FIG. 3 described above. Therefore description of the processing carried out in step S21 to step S23 is omitted here.

The more contents (content vectors) not relevant to the user's experience are included in the metadata matrix D generated as a result of processing in step S21, the approximated matrix Dₖ generated as a result of the processing in step S23 has the lower relativity with the cooccurrence of metadata specific to the user, and therefore a matrix based on consideration for the cooccurrence in the general sense is provided. Therefore, the metadata extracted as important metadata as a result of the processing in step S26 described hereinafter based on the components value in the approximated matrix Dₖ as described above or on the feature differences obtained from the approximated matrix Dₖ has lower property emergence for a user, so that a user should be careful in using the metadata. In other words, when it is necessary to extract metadata having higher property emergence to a user, the contents that the user has already experienced should be included in the metadata matrix D generated as a result of processing in step S21 as much as possible.

When the approximated matrix Dₖ is generated by the LSA computing section 20 as a result of processing in step S23, the processing flows to step S24.

In step S24, the LSA processing section 20 determines whether or not a feature difference should be used in the processing in step S26 described hereinafter and executed by the metadata extracting section 21.

When it is determined in step S24 that a feature difference should be used, the LSA processing section 20 computes feature differences for metadata in step S25. The processing in step S25 is basically the same as the processing in step S4 shown in FIG. 3. Therefore a detailed description of the processing in step S25 is omitted here.

Then when the approximated matrix Dₖ and feature differences for the metadata are supplied from the LSA computing section 20 to the metadata extracting section 21, the processing flows to step S26.

In contrast, when it is determined in step S24 that a feature difference is not to be used, only the approximated matrix Dₖ is supplied from the LSA computing section 20 to the metadata extracting section 21, and the processing flows to step S26.

In step S26, the metadata extracting section 21 identifies one or more piece of metadata to be recommended, namely important metadata by using at least one of the components value in the approximated matrix Dₖ and feature differences for metadata, and extracts the one or more identified important metadata from the metadata storing section 16.

There is not any specific restriction over the technique for extracting important metadata in step S26, and for instance, the following technique may be employed.

For instance, such an extracting technique may be applied in which an average value for all components in the approximated matrix Dₖ or metadata corresponding to a highest component value in a particular content vector specified by a user (or any desired number of metadata from the highest one) may be extracted. To sum up, the extracting technique using component values in the approximated matrix Dₖ may be applied.

Further also such an extracting technique may be applied in which metadata having the highest feature difference (or any desired number of metadata from the one having the highest feature difference) is extracted as important metadata, or in which metadata with the weight values raised is extracted as important metadata may be extracted. To sum up, the extracting technique using a feature difference may be applied.

More specifically, it is assumed for the following descriptions that the metadata matrix D described in the first embodiment with reference to FIG. 4 was generated as a result of processing in step S21 through step S23, and also that the approximated matrix Dₖ shown in FIG. 5 was generated. Further it is assumed in step S25 that the feature differences for the metadata shown in FIG. 6 were computed by the second feature difference computing technique using the difference values between the approximated matrix Dₖ shown in FIG. 5 and the metadata matrix D shown in FIG. 4.

In this case, in the processing in step S26, if metadata each having a feature difference of 0.05 or more is extracted, “toufu” and spa” are extracted.

When one or more important metadata extracted by the metadata extracting section 21 is supplied to the content recommending section 23, the processing flows to step S27.

In step S27, the content recommending section 23 determines whether or not the contents should be recommended.

When it is determined in step S27 that the contents should not be recommended, the processing flows to step S28.

In step S28, the content recommending section 23 presents one or more important metadata extracted by the metadata extracting section 21 in the processing in step S26 via the user interface section 11 to the user.

With the operation above, the “recommending processing in consideration of cooccurrence relation” is terminated.

When it is determined in step S27 that the contents should be recommended, the processing flows to step S29. More accurately, when it is determined in step S27 that the contents should be recommended, the content recommending section 23 supplies one or more important data extracted by the metadata extracting section 21 to the vector computing section 22 and also executes the matching processing. Then the processing flows to step S29.

In step S29, the vector computing section 22 executes the contents matching processing using a metadata group consisting of the one or more important metadata extracted by the metadata extracting section 21 in the processing in step S26. In step S29, the vector computing section 22 regards the metadata group as one content (content vector), computes similarity between the content and other contents (content vector) stored in the content storing section 15, selects content with the highest similarity (or any desired number of contents from that with the highest similarity) and sends the selected contents to the content recommending section 23.

In step S28, the content recommending section 23 recommends the one or more contents selected by the vector computing section 22 in the processing in step S29. In step S28, the content recommending section 23 presents metadata for the one or more contents (or the metadata or other related information) via the user interface section 11 to the user.

With the operation above, the “recommending processing in consideration of cooccurrence relation” is terminated.

The information processing system or information processing apparatus, namely the information processing system or information processing apparatus for executing the “recommending processing in consideration to cooccurrence relation” was described above with reference to FIG. 7 and FIG. 8.

In the second embodiment, the approximated matrix Dₖ is obtained, and by using the approximated matrix Dₖ or a difference between the approximated matrix Dₖ and the original metadata matrix D, weight is performed with consideration of cooccurrence relation between metadata at the latent semantic level. A feature difference, which is an index value indicating importance in consideration of cooccurrence relation for metadata, can be obtained.

Therefore, by making use of component values in the approximated matrix Dₖ in consideration of cooccurrence relation, or an index value (weight value) of the important in consideration of cooccurrence relation, it is possible to find out metadata apparently irrelevant, or those apparently relevant but actually having low relativity, and to sort contents based on the metadata.

In other words, the metadata apparently irrelevant but actually important may be considered as metadata having high property emergence not having been noticed by a user, namely important data. Also the contents recommended based on the important data as described above may also be considered as contents having high property emergence.

The information processing system or information processing apparatus as described above may also be applied to sorting of attributes (metadata) generally referred to as feature selection in the field of data mining or document classification. In other words, the sorting processing of attributes (metadata) in consideration of cooccurrence relation of metadata can easily be realized.

### Third Embodiment

Next, third embodiment is described below.

As a generating technique of a user preference vector (UPV) for a content recommending system based on the vector space method, there has been often employed a generating technique of generating a UPV by averaging content vectors in a group of contents to which a user gives high appreciation. The UPV generated with such a generating technique is a vector making various preferences of a user blunt, and when contents is recommended using a UPV as described above, there has been a problem that a broad range of recommendation of contents is difficult to make. Further, even if a group of contents given high appreciation is subjected to clustering into a plurality of groups in order to increase variety, there has been a problem that recommendation of contents that a user has never been experienced is difficult to make.

In order to solve the problems, the present inventor invented the third processing described above, namely, the “processing of recommendation making use of a difference of a group of UPVs subjected to clustering”.

Outline of the third processing is described below.

An information processing system or information processing apparatus according to the third embodiment (described simply as a device in the description of outline of the third processing) subjects, in a metadata space or conceptual space, a content vector given high appreciation by a user to clustering into a plurality of clusters (groups) using a prespecified algorithm.

The device computes a representative vector for respective clusters by averaging one or more content vectors belonging to corresponding clusters (described as a representative vector hereinafter), and further generates difference vectors between the representative vectors for respective clusters (described as representative UPVs hereinafter).

A group of vectors including representative vectors for respective groups in the third embodiment is a group of conventional UPVs having been subjected to clustering. Difference vectors between the representative vectors for respective clusters indicate vectors generated by differences of conventional UPVs having been subjected to clustering. Thus the difference vectors between the representative vectors for respective clusters are referred to as difference UPVs.

The device conducts matching processing of contents making use of difference UPVs, and recommends appropriate contents based on the result of the matching processing.

A notable point herein is that a difference UPV is a vector indicating a preference not represented (impossible to be computed) using an average of content vectors (conventional UPVs). Thus the use of the difference UPV enables recommendation of such contents that a user has not been aware of so far.

The outline of the third embodiment, namely, the “processing of recommendation making use of a difference of a group of UPVs subjected to clustering” has been described above.

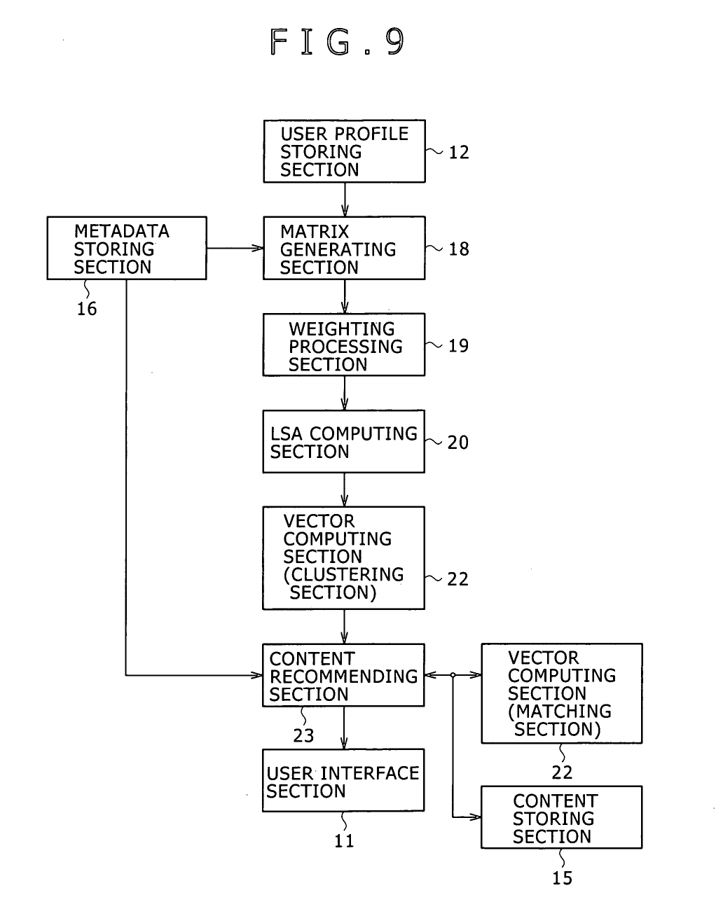

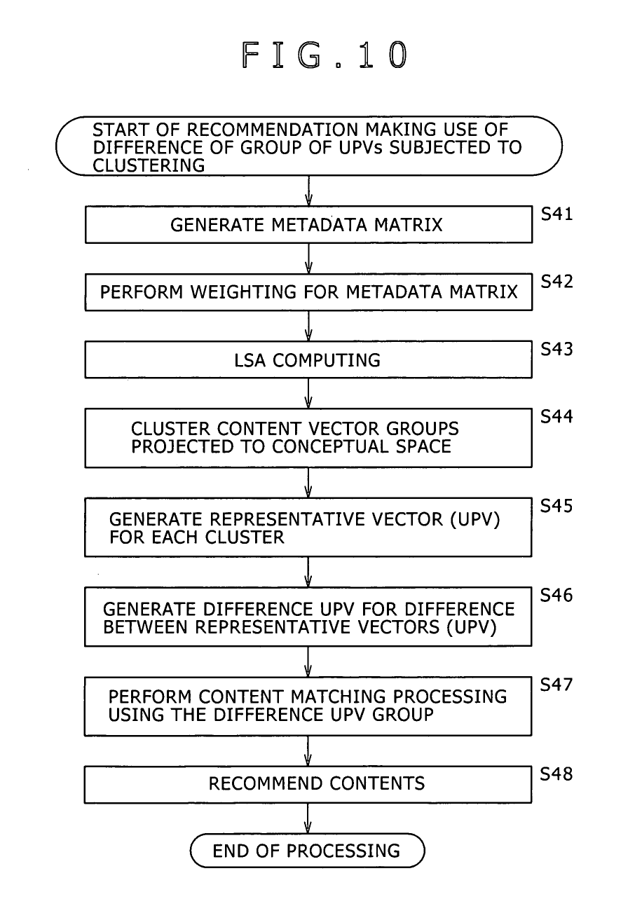

Next, descriptions are provided below for the information processing system or information processing apparatus according to the third embodiment of the present invention, namely the information processing system or information processing apparatus for executing “processing of recommendation making use of a difference of a group of UPVs subjected to clustering” is described below with reference to FIG. 9 and FIG. 10.

FIG. 9 is a view showing an example of functional configuration of the information processing system or information processing apparatus according to the third embodiment of the present invention.

In other words, blocks required for execution of “processing of recommendation making use of a difference of a group of UPVs subjected to clustering” are extracted from all blocks in the user interface section 11 through the content recommending section 23 shown in FIG. 1, and the FIG. 9 is a view showing the situation in which the blocks are arrayed according to a flow of information when “processing of recommendation making use of a difference of a group of UPVs subjected to clustering” is executed. The blocks shown in FIG. 9 are described above with reference to FIG. 1, and descriptions thereof are omitted here.

Though not shown in FIG. 9, actually within each arrow mark connecting two blocks, namely, between the two blocks, the information transfer section 24 shown in FIG. 1 is provided.

FIG. 10 is a flow chart for illustrating an example of the “processing of recommendation making use of a difference of a group of UPVs subjected to clustering”. An example of the “processing of recommendation making use of a difference of a group of UPVs subjected to clustering” is described below with reference to the flow chart shown in FIG. 10.

Each of steps 41 and 42 shown in FIG. 10 is basically the same as the steps S1 to S3 shown in FIG. 3 described above. Therefore description of the processing carried out in step S41 and step S42 is omitted here.

For instance, it is assumed that, as metadata matrix D with N rows and M columns weighted in processing in step S41 and step S42, matrix A including content vectors given high appreciation by users is generated. Each column component of matrix A, namely, each of the content vectors is described hereinafter as ai (i=0, 1, . . . , m−1). Matrix A is expressed by the following formula (3):
A=(a0, a1, . . . , am−1) (3)

In this case, in step S43, the LSA computing section 20 executes LSA computing for metadata matrix A expressed by this formula (3).

It is to be noted that processing in step S43 according to the third embodiment, a first processing and a second processing are executed among the LSA computing.

More specifically, as indicated by the formula (1) described above, matrix A is decomposed into three component columns U, Σ, and V by singular value decomposition.

Next the component column U is compressed to k-th dimension, and thus a projection matrix Uₖ is obtained. The projection matrix Uₖ refers to a matrix taking only k pieces of column components (column vectors) counting from that having a larger singular value, and the other components having a value of 0.

Thus matrix A is projected to a conceptual space by projection matrix Uₖ. The resultant matrix is described hereinafter as, for instance, matrix B. In this case, the term “matrix A is projected to a conceptual space by projection matrix Uₖ” refers to that computing according to the following formula (4) is performed. In the formula (4), matrix Uₖ^{T} represents a transposed matrix of projection matrix Uₖ.
B=Uₖ^{T}A (4)

Each of the column components (content vectors) of matrix B is described hereinafter as bi (i=0, 1, . . . , m−1). Matrix B is expressed by the following formula (5):
B=(b0, b1, . . . , bm−1) (5)

This column vector bi is a content vector compressed to k-th dimension, namely, a content vector projected to a conceptual space.

In the processing in step S43, each content vector bi projected to a conceptual space is obtained. It is to be noted that a set of each content vector bi projected to a conceptual space, namely matrix B is referred to as a group of content vectors projected to a conceptual space.

Then, in step S44, the vector computing section 22 performs clustering to a group of content vectors projected to a conceptual space with processing of the LSA computing section 20 in step S43. In step S44, the vector computing section 22 classifies each content vector bi projected to a conceptual space into a given number of and a given kinds of clusters making use of a prespecified algorithm.

As described above, the vector computing section 22 for executing the processing in step S44 is equivalent to a clustering section 22. Thus the vector computing section 22 shown below the LSA computing section 20 in FIG. 9 is indicated also as the clustering section 22 in parenthesis.

More specifically, for instance, in step S44, it is assumed that each of the content vectors bi projected to a conceptual space is classified into any of the number s of clusters.

Next, in step S45, the vector computing section 22 generates representative vectors (UPVs) respectively. In this case, in step S45, the vector computing section 22 generates an average vector of one or more content vectors bi belonging to a corresponding cluster of the number S of clusters, and the average vector is referred to as a representative vector (UPV).

It is to be noted that the representative vector is hereinafter described as cj′ (j=0, 1, . . . , s−1).

In step S46, the vector computing section 22 generates a difference UPV which is a difference between the representative vectors. In step S46, the vector computing section 22 generates a difference UPV by computing a difference of a prespecified pair of representative vectors among the representative vectors cj′ in the number s of clusters.

The number of combination of a pair of clusters as described above varies according to the number s of clusters, and, when the number s of clusters is three or more, the number of combination is naturally a plurality. Therefore, in this case, if a difference UPV is generated for every pair of combination, a plurality of difference UPVs are to be generated.

More specifically in this case for instance, with processing in step S46, the right side of the following formula (6) is computed to generate each of vectors d′p, q as each difference UPV. It is to be noted that in the formula (6); p, q=0, 1, . . . , s−1. Note that p≠q.
d′p, q=c′p−c′q (6)

A pair of representative vectors for generating a difference vector is not especially required to use every combination, and a given number of a given combination may be used. In any case, one or more difference UPV is generated with the processing in step S46. Thus one or more difference UPV is referred to as a group of difference UPVs. As a group of difference UPVs is generated with the processing in step S46.

Further, in the processing in step S46, the vector computing section 22 may order each difference UPV belonging to a group of difference UPVs according to a prespecified rule, such as in the descending order of a value of a first main component (a vector base value paring to the highest singular value by singular value decomposition) in the conceptual space.

The vector computing section 22 reports, upon generating a group of difference UPVs, the generation to the content recommending section 23. Then the content recommending section 23 demands matching processing to the vector computing section 22, and the processing flows to step S47.

In step S47, the vector computing section 22 executes matching processing of the contents utilizing a group of difference UPVs generated with the processing in step S46.

In step S47, the vector computing section 22 computes similarity between respective difference UPVs belonging to a group of difference UPVs and other contents (content vectors) stored in the content storing section 15, selects contents with the highest similarity (or any desired number of contents from that with the highest similarity) and sends the selected contents to the content recommending section 23.

More specifically in this case for instance, each of the vectors d′p, q (p, q=0, 1, . . . , s−1. Note that p≠q) belongs to a group of difference UPVs, so that with the processing in step S47, similarity with respect to every p, q (or a prespecified number counting from the top) between corresponding vectors d′p, q and newly found content vectors.

Unlike the vector computing section 22 for executing the processing in step S44, the vector computing section 22 for executing the processing in step S47 may be equivalent to a matching section 22. Thus the vector computing section 22 shown next to and on the right side of the content recommending section 23 in FIG. 9 is indicated also as the matching section 22 in parenthesis.

In step S48, the content recommending section 23 recommends one or more contents selected by the vector computing section 22 with the processing in step S47. In step S48, the content recommending section 23 presents one or more contents described above (or metadata thereof or related information) to a user via the user interface section 11.

With this operation, the “processing of recommendation making use of a difference of a group of UPVs subjected to clustering” is terminated.

Descriptions have been provided above for the information processing system or information processing apparatus according to the third embodiment of the present invention, namely the information processing system or information processing apparatus for executing the “processing of recommendation making use of a difference of a group of UPVs subjected to clustering” has been described with reference to FIG. 9 and FIG. 10.

In the third embodiment, advantages as described below can be provided. When based on the technique in related art, as described above, UPVs are generated from an average of content vectors given high appreciation by a user or the like. Thus the contents having high similarity to such UPVs are necessarily similar to those already having been experienced by a user, and there has been a problem that a range of a variety for recommending contents is narrowed. By contrast, in the third embodiment, contents is recommended based on the result of matching processing making use of difference UPVs, so that advantages can be provided that allows a recommendation of contents not having been experienced by a user as well as reflecting the user's preference to some extent.

These advantages in the third embodiment are more obvious, not when difference UPVs in a metadata space are used but when difference UPVs in the conceptual space are used. The reason is described below. For an easy understanding, descriptions are provided with reference to each of the steps shown in the flow chart in FIG. 10 described above according to the necessity.

In the metadata space before projection, namely before the processing in step S43, when metadata matrix D is generated making use of, for instance, a frequency of appearance of words in texts, a column component of the matrix, namely, a negative vector element of a content vector (which is a negative component value, and described hereinafter as a negative element) does not take on any meaning.

Thus, in the metadata space, a group of content vectors is subjected to clustering, and representative vectors (UPVs) for each cluster are generated. Even when a difference between the representative vectors is computed, a negative element cannot be used as appropriate information in matching processing between the resultant difference UPV and contents (content vectors).

On the other hand, after the processing in step S43, namely, in the conceptual space obtained from a result of projection of a metadata space with singular value decomposition, as described above, each content vector has a negative element.

Thus, in the conceptual space, when difference UPVs obtained from a result of processing in step S44 to step S46 described above are used in matching processing in step S47, all elements including a negative element are valid.

More specifically, for instance, in the processing in step S44, it is assumed that clustering is carried out in a conceptual space according to user's preferences, and a representative vector c1 indicating a first preference is highly weighted with conceptual bases e1, e2, e3, while representative vector c2 indicating a second preference, which is different from the first preference, is highly weighted with conceptual bases e2, e3, e4. It is to be noted that, to simplify descriptions, all of the weighted values (component values) for e1 to e4 are positive.

The term of the conceptual base refers to a base for forming a conceptual space, and more specifically, for instance, refers to each column component (column vector) of the component matrix U obtained when the metadata matrix D is decomposed with singular value according to the formula (1) described above.

In this case, a highly-weighted positive value for conceptual base e1 and a highly-weighted negative value for conceptual base e4 remain in the vector (c1−c2), which is a difference UPV between the representative vector c1 and the representative vector c2. In the conceptual base e2 and conceptual base e3, as the result of taking a difference between the highly-weighted value and another highly-weighted value, both weighted values are offset to each other, so that the absolute value of the weighted values comes to a much lower value as compared to each absolute value of the weighted values for conceptual base e1, e4.

Thus, in step S47, it can be said that the contents matching up to the difference UPV in such a conceptual space has a high weight in the metadata projected to the conceptual base e1, and has a high weight in the metadata negatively projected in relation to the conceptual base e4. Even when the metadata negatively projected in relation to the conceptual base e4 has some connection with the metadata positively projected for the conceptual bases e1 to e4, there is a possibility that the negatively projected metadata is not attached to the contents already having been experienced by a user. Therefore the metadata negatively projected for the conceptual base e4 is also included in the target for matching processing, thereby making it possible to recommend such contents as being capable of attracting a user's new interest.

The matter described above is a reason why the advantages according to the third embodiment described above become more obvious with difference UPVs in the conceptual space, as compared to those with difference UPVs in the metadata space.

### Fourth Embodiment

A fourth embodiment of the present invention is described below.

Also in the related art, content recommendation based on evaluation by users has been practiced. The technique for content recommendation making use of concerted filtering and user evaluation values is disclosed, for instance, in P. Resnick, N. Iacovou, M. Suchak, P. Bergstrom, and J. Riedl. “GroupLens Open Architecture for Collaborative Filtering of Newnews.” Conference on Computer Supported Cooperative Work, pp. 175-186, 1994. Further the technique for using the LSA and user evaluation value is disclosed in Japanese Patent Laid-Open No. 2002-269143.

With the techniques as described above, however, only similarity between evaluations by different users is used, and change of evaluation by a single user with time for contents having similar tendencies and contents of evaluation are not taken into consideration. Therefore, the contents recommended by the techniques as described above do not disadvantageously always satisfy the user's preference.

To solve the problem as described above, the present inventor invented the fourth processing, namely the “contents evaluating processing by LSA” as described above.

The fourth processing is described below.

For instance, it is assumed that a number of contents which a user experienced (new contents) increases, and that the information processing system or information processing apparatus according to the fourth embodiment (described simply as a device in the following description of the fourth embodiment) updates, in association with the increase, the metadata matrix D by adding the content vectors for new contents to the original metadata matrix D and further generates the approximated matrix Dₖ for the updated metadata matrix D. Namely it is assumed that the approximated matrix Dₖ is updated.

In this case, components of content vectors included in the original approximated matrix Dₖ changes to those in the updated approximated matrix Dₖ.

To solve this problem, in the fourth embodiment, a content vector also having, in addition to metadata, an evaluation value by a user as a base is used, and a metadata matrix D is generated from the content vectors.

Then when a number of contents (new contents) experienced by the user increases and also the user's evaluation value for the new contents are inputted, the new contents are vectorized by referring the user's evaluation values each as a base. With this operation, content vectors for the new contents are generated. Then the device updates the metadata matrix D by adding the content vectors for the new contents to the original metadata matrix D, and generates the approximated matrix Dₖ for the updated metadata matrix D. Namely the approximated matrix Dₖ is updated.

In this case, as described above, also the evaluation values for the existing contents similar to the new contents (corresponding evaluation values in the updated approximated matrix Dₖ) also change according to the evaluation values for the content vectors for the new contents (corresponding component values in the updated metadata matrix D).

In other words, it may be said that the device re-evaluates the existing contents (updates evaluation values for the existing contents) by updating the approximated matrix Dₖ so that the content vectors for the new contents are included therein.

With the re-evaluation of the existing contents, there occurs a case in which an evaluation value for contents not satisfying the reference value for recommendation to a user satisfies the reference value after execution of LSA. In the case as described above, the device can recommend the contents having an evaluation value not less than the reference value after execution of LSA or those similar to the contents to the user. Namely the device can recommend contents satisfying the user's current preference from the contents which were not objects for recommendation and ignored in the past. In other words, the device can respond to user's preference with time.

Outline of the fourth processing, namely the “contents re-evaluating processing by LSA” is as described above.

Then, the information processing system or information processing apparatus according to the fourth embodiment, namely the information processing system or information processing apparatus for executing the “contents re-evaluating processing by LSA” is described below.

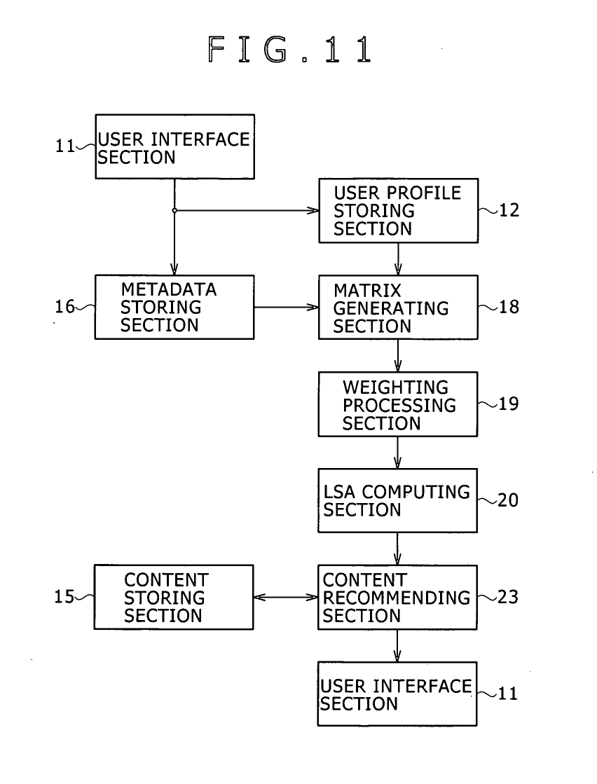

FIG. 11 shows an example of functional configuration of the information processing system or information processing apparatus according to the fourth embodiment.

In other words, blocks required for execution of the “contents re-evaluating processing by LSA” are extracted from the all blocks from the user interface section 11 to the content recommending section 23 shown in FIG. 1, and the blocks are arrayed according to information flow when the “contents re-evaluating processing by LSA” is executed. The situation is shown in FIG. 11. Each of the blocks shown in FIG. 11 was already described with reference to FIG. 1, and description thereof is omitted herefrom.

Although not shown in FIG. 11, the information transfer section 24 shown in FIG. 1 is provided in each arrow connecting two blocks, namely between the two blocks.

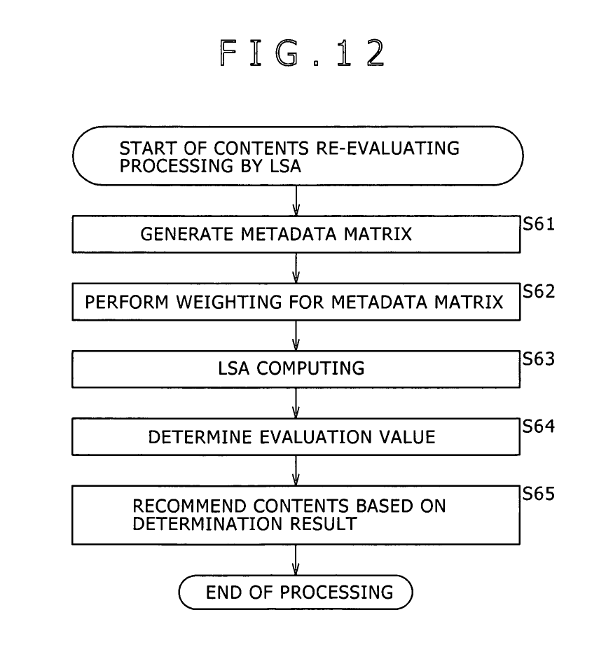

FIG. 12 is a flow chart for illustrating the “contents re-evaluating processing by LSA”. An example of the “contents re-evaluating processing by LSA” is described below with reference to the flow chart shown in FIG. 12.

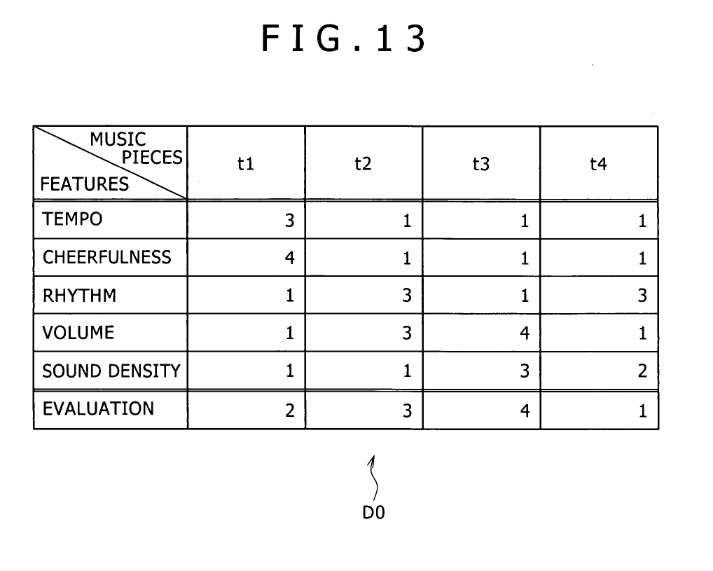

To facilitate understanding of the “contents re-evaluating processing by LSA”, descriptions are provided below with reference to FIG. 13 to FIG. 16 according to the necessity. Namely FIG. 13 to FIG. 16 show a specific example of a result of the “contents re-evaluating processing by LSA”.

Herein, for instance, it is assumed that music pieces are regarded as contents objects to be processed, and features of the music pieces are employed as metadata as shown in FIG. 13 to FIG. 16. More specifically, it is assumed that the five features of “tempo”, “cheerfulness”, “rhythm”, “volume”, and “sound density” are employed. Further it is assumed that, in addition to the five features, a user's evaluation value for the music pieces is added as a base for a content vector. In other words, the content vectors in this case has the form of (“tempo”, “cheerfulness”, “rhythm”, “volume”, “sound density”, and “evaluation”).

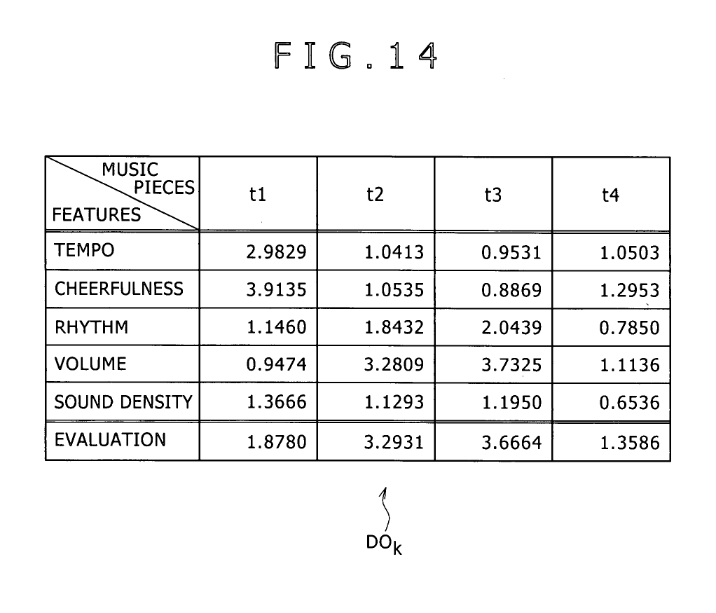

Further it is assumed in the following descriptions that the “contents re-evaluating processing by LSA” for the four music pieces t1 to t4 as objects for processing was performed in the past, the metadata matrix D0 shown in FIG. 13 was generated in the processing, and also that the approximated matrix D0ₖ shown in FIG. 14 was generated as a result of two dimensional compression of the metadata matrix D0 by LSA computing.

As shown in FIG. 13, the metadata matrix D0 is a matrix having six rows and four columns and including content vectors for the music pieces t1 to t4 as components for first to fourth columns. Content vectors for the music piece t1 are (3,4,1,1,1,2). Content vectors for the music piece t2 are (1,1,3,3,1,3). Content vectors for the music piece t3 are (1,1,1,4,3,4). Content vectors for the music piece t4 are (1,1,3,1,2,1).

Further, as shown in FIG. 14, the approximated matrix D0ₖ is a matrix having six rows and four columns and including content vectors updated as described below for the music pieces t1 to t4 as components for first to fourth columns. The updated content vectors for the music piece t1 are (2.9829, 3.9135, 1.1460, 0.9474, 1.3666, and 1.8780). The updated content vectors for the music piece t2 are (1.0413, 1.0535, 1.8432, 3.2809, 1.1293, 3.2931). The updated content vectors for the music piece t3 are (0.9531, 0.8869, 2.0439, 3.7325, 1.1950, 3.6664). The updated content vectors for the music piece t4 are (1.0503, 1.2953, 0.7850, 1.1136, 0.6536, 1.3586).

It is further assumed that the user then listened to the new music piece t5, and evaluated the new music piece t5 by using the under interface section 11 shown in FIG. 11. In this case, ID of the new music piece t5 and the evaluation value are stored in the user profile storing section 12, and “tempo”, “cheerfulness”, “rhythm”, “volume”, and “sound density” for the new music piece t5 are stored in the metadata storing section 16.

Further it is assumed that the “contents re-evaluating processing by LSA” shown in FIG. 12 is started.

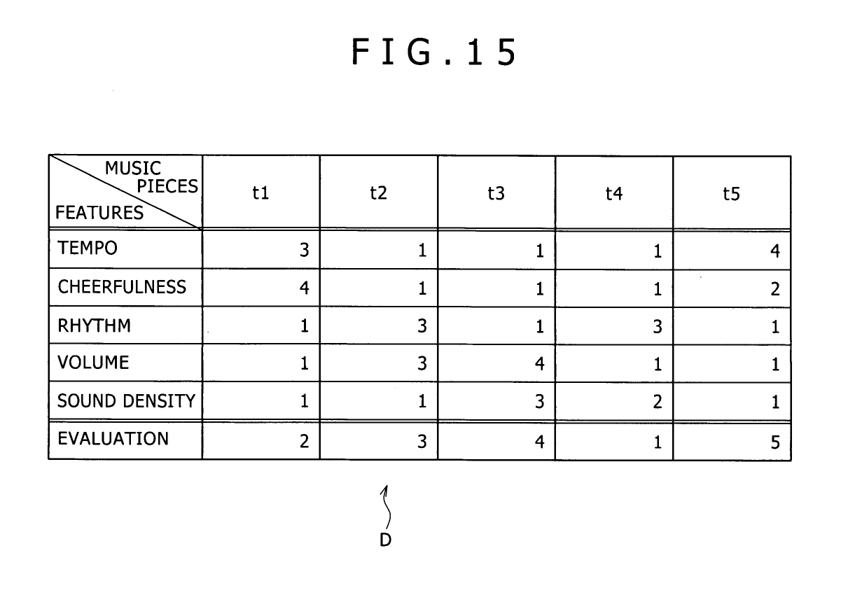

In this case, the processing steps similar to steps S1 and S2 shown in FIG. 3 are executed in step S61 and S62, and for instance, the metadata D as shown in FIG. 15 are generated by the matrix generating section 18.

More precisely, (4,2,1,1,1,5) are generated as content vectors for the music piece t5, and the content vectors for the music piece t5 are added to the metadata matrix D0 shown in FIG. 13, thus the metadata matrix D shown in FIG. 15 being generated.

As described above, with the processing in step S61 and S62, a matrix having six rows and five columns and including content vectors for the music pieces t1 to t5 as components for the first to fifth columns is generated as a metadata matrix D. When the metadata matrix D is supplied from the weighting processing section 19 to the LSA computing section 20, the processing flows to step S63.

Again in FIG. 12, the LSA computing section 20 executes LSA computing in step S63 for the metadata matrix shown in FIG. 15.

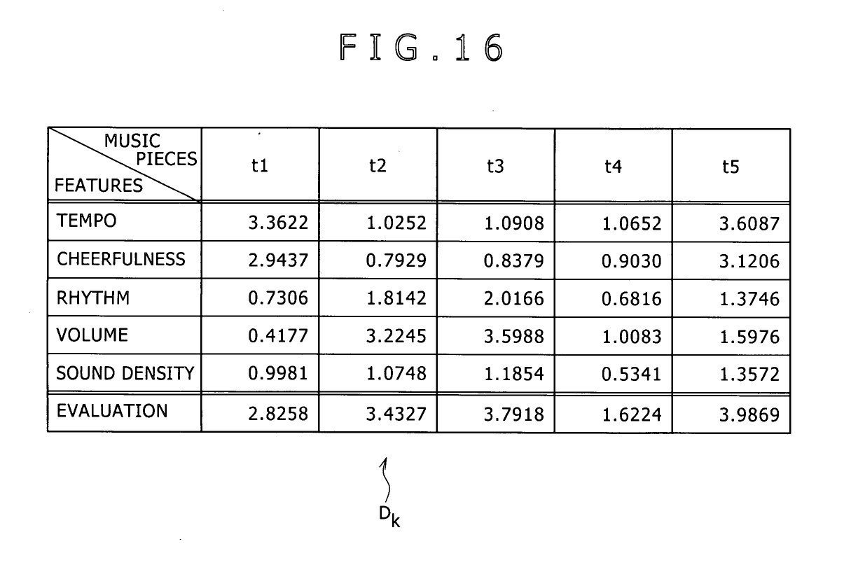

In this case, as the processing in step S63, the first processing and third processing in the LAS computing are executed, and as a result, for instance, the approximated matrix Dₖ compressed to two dimensions as shown in FIG. 16 is generated.

In other words, in the case described above, as a result of processing in step S63, the approximated matrix Dₖ having six rows and five columns and including the content vectors for the music pieces t1 to t5 updated as described below as column components for the first to fifth columns is generated.

Namely, the content vectors for the updated music piece t1 are (3.3622, 2.9437, 0.7306, 0.4177, 0.9981, 2.8258). The content vectors for the updated music piece t2 are (1.0252, 0.7929, 1.8142, 3.2245, 1.0748, 3.4327). The content vectors for the updated music piece t3 are (1.0908, 0.8379, 2.0166, 3.5988, 1.1854, 3.7918). The content vectors for the updated music piece t4 are (1.0652, 0.9030, 0.6816, 1.0083, 0.5341, 1.6224). The content vectors for the updated music piece t5 are (3.6087, 3.1206, 1.3746, 1.5976, 1.3572, 3.9869).

When the approximated matrix Dₖ is supplied from the LSA computing section 20 to the content recommending section 23, the processing flows to step S64.

In step S64, the content recommending section 23 determines evaluation values for the contents. In step S65, the content recommending section 23 recommends the contents based on a result of the determination. With this operation, the “contents re-evaluating processing by LSA” is terminated.

There is not specific restriction over the technique for determining evaluation values of the contents in step S64, and various techniques for evaluation may be employed. For instance, when the “evaluation” component in the approximated matrix Dₖ satisfies the first to third conditions for each of the content vectors, it may be determined that the corresponding contents should be recommended to the user. Further based on the determination method as described above, a technique may be employed in which the contents experienced by a user just recently is not recommended and high weights are given to contents having a prespecified period of time after storage taking into consideration of a change degree of the user's preference with time.

The first condition above is that a value of the “evaluation” component in the approximated matrix Dₖ has become larger as compared to a value of the corresponding component in the original metadata matrix D.

The second condition is that the value of the “evaluation” component in the approximated matrix Dₖ has become larger as compared to a prespecified threshold value.

The third conditions is that the feature difference computed from a value of the “evaluation” component in the approximated matrix Dₖ or a difference between a value of the evaluation component in the approximated matrix Dₖ and a value of corresponding component in the original metadata matrix D, or a difference value as described above computed from a quotient is larger than a prespecified threshold value.

More specifically, suppose that, in the case described above, the second condition is employed and a value of 2.5 is set as a threshold value. In this case, the contents each having the “evaluation” contents value in the approximated matrix Dₖ are the music piece t1, music piece t2, music piece t3, and music piece t5. Therefore, in step S64, it is determined that the music piece t1, music piece t2, music piece t3, and music piece t5 are contents to be recommended, and in step S65, the music piece t1, music piece t2, music piece t3, and music piece t5 are recommended.

What is important herein is the following point.

When attention is paid to the music piece t1, as shown in FIG. 13, the original evaluation value for the music piece t1, namely a value of the “evaluation” component is a low value of 2. Further, because the music piece t1 is not similar to music pieces t2 to t4, also a value of the “evaluation” component for the music piece t1 after updated by the LSA computing is 1.8780 as shown in FIG. 14 which is smaller than the threshold value 2.5. Therefore, before the user listened to the new music piece t5, the music piece t1 was not recommended.

However, after the point of time, the user listened to the new music piece t5 and gave a high evaluation to the new music piece t5. Namely the “evaluation” component value for the music piece t5 is a high value of 5, and in addition this music piece t5 is most similar to the music piece t1 among the music pieces t1 to t4. Therefore, when the LSA computing is performed to the metadata matrix D including this music piece t5 shown in FIG. 15, because of the high evaluation value of the music piece t5, and also based on the relativity of metadata (features of the music), also the “evaluation” component value for the music piece t1 similar to the music piece t5 is updated to a high value of 2.8258. Therefore, the music piece t1 not recommended because of a low evaluation value (provably not recommended because of the low evaluation value) can be recommended to the user based on the user's recent preference, namely the high evaluation value given by the user to the music piece t5.

As described above, in the fourth embodiment, the approximated matrix Dₖ is updated so that the content vectors for the new contents are included therein, so that re-evaluation of the existing contents (update of the evaluation values) is performed. With the operation described above, contents satisfying a current user's preference among the contents not regarded as objects for recommendation in the past, namely among the contents not recommended and ignored in the past can be recommended. In other words, change in user's preference can be taken into consideration.

### Fifth Embodiment

Next, a fifth embodiment is described below.

As described above, a content vector for contents is a vector having metadata as a base. When a large quantity of metadata is used as a base for a content vector, it is natural that metadata of various types each being different in property is often mixed together. For instance, there exists a certain type of metadata not influenced in its nature by other types of metadata, and there are many cases in which metadata of various types each being different in a degree of influencing other data or being influenced by other data is mixed.

However, in recommendation of contents according to the conventional technique, a difference of property of the metadata, for instance, a degree of influencing other data or being influenced by other data, has not taken into consideration so that there is a problem that the contents suited for a user is not necessarily recommended.

For instance, various types of algorism (weighting technique) used for weighting metadata is not suitable for metadata having any given property, and in most cases, is suitable for metadata having a certain property, but is not for that having another property. Nevertheless, the same algorism has been employed for weighting to any type of metadata despite of such a difference in property. When recommendation of contents is carried out making use of the metadata weighted as described above, there has been a problem that the contents is not necessarily suited for a user.

Thus, in order to solve the problems, the present inventor invented the fifth processing described above, namely, the “processing of recommendation with a hybrid of LSA and other technique”.

Outline of the fifth processing is described below.

As described above, there are cases where metadata can be classified into some types according to its property, and a suitable weighting algorism differs according to each type of metadata.

In this case, an information processing system or information processing apparatus according to the fifth embodiment (described simply as a device in the description of outline of the fifth processing) executes weighting processing for a matrix employed in matching with respect to each type of metadata.

The device performs matching processing for contents making use of a matrix weighted as described above. With this operation, more suitable matching processing is possible as compared to the conventional processing.

Further the device can change the weight by multiplying a component value computed with a corresponding algorism by a prespecified coefficient for 2 or more algorisms.

For instance, it is assumed herein that the contents is an e-mail, and the words, sent/received time zones, senders/receivers and places for an e-mail are employed as metadata. In this case, the device, for instance, classifies the words in the e-mail as a first type, and the other three elements, namely, the sent/received time zones, senders/receivers and places as a second type.

Next, the device generates a metadata matrix, and divides the metadata matrix into a first sub-matrix including components corresponding to the first type of metadata and a second sub-matrix including components corresponding to the second type of metadata.

Next, the device executes, for instance weighting processing to the first sub-matrix by weighting with a general weighting algorism such as TF/IDF, while to the second sub-matrix by weighting with a second weighting algorism such as LSA. It is to be noted that a combination of algorisms is not limited to this example, and any combination is naturally applicable.

Then the device synthesizes the first sub-matrix and the second sub-matrix having been weighted with different algorisms as described above, and performs matching processing making use of a matrix obtained from a result of the synthesis (referred to as an approximated synthesized matrix hereinafter).

Outline of the fifth processing, namely, the “processing of recommendation with a hybrid of LSA and other technique” has been described above.

The metadata including the sent/received time zones, senders/receivers and places described above is referred to as a context. Namely, the context herein refers to all the internal state and the external state of a user. The internal state of a user refers to a user's physical condition, or emotion (mood or state of mind). The external state of a user refers to a user's spatial or temporal location (a temporal location refers to, for instance, the current time) and a prespecified state distributed in the spatial direction or in the temporal direction surrounding a user.

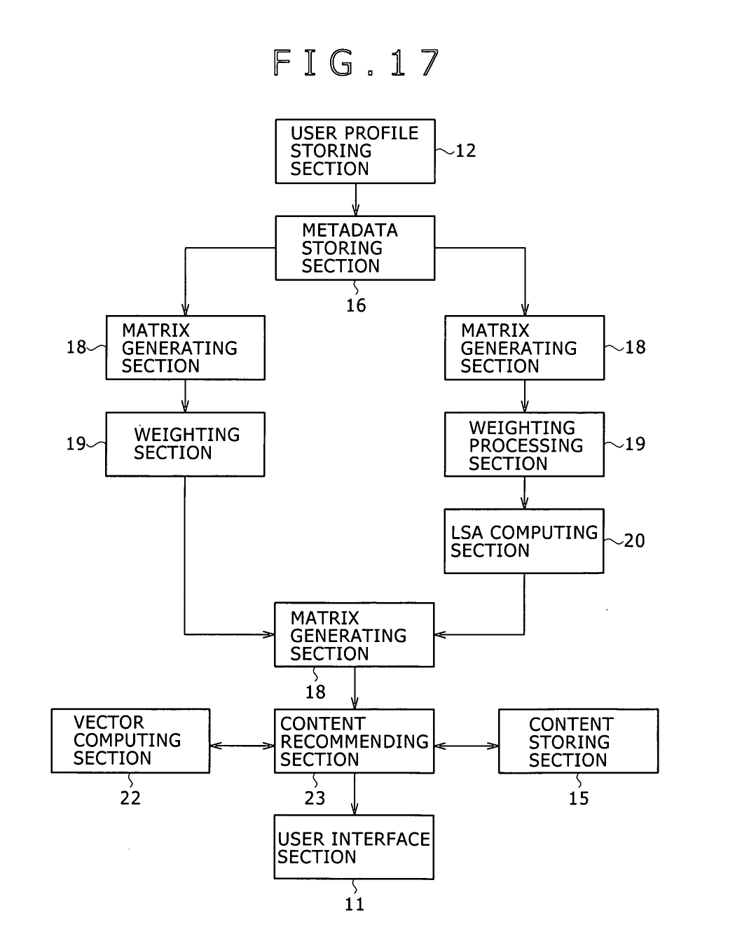

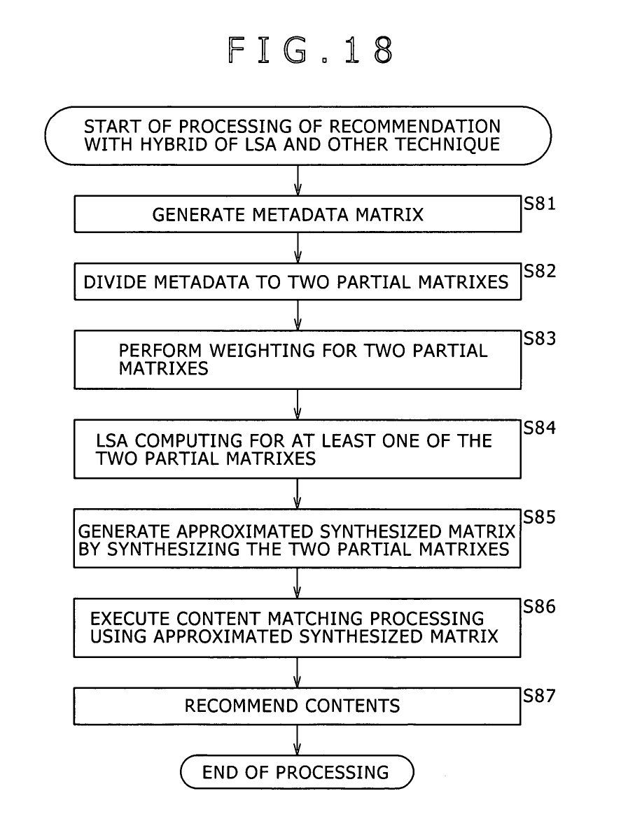

Next, descriptions are provided below for the information processing system or information processing apparatus according to the fifth embodiment of the present invention, namely the information processing system or information processing apparatus for executing the “processing of recommendation with a hybrid of LSA and other technique” is described below with reference to FIG. 17 and FIG. 18.

FIG. 17 is a view showing an example of functional configuration of the information processing system or information processing apparatus according to the fifth embodiment.

In other words, blocks required for execution of “processing of recommendation with a hybrid of LSA and other technique” are extracted from all blocks in the user interface section 11 through the content recommending section 23 shown in FIG. 1, and the FIG. 17 is a view showing the situation in which the blocks are arrayed according to a flow of information when “processing of recommendation with a hybrid of LSA and other technique” is executed. The blocks shown in FIG. 17 are described above with reference to FIG. 1, and descriptions thereof are omitted herefrom.

Though not shown in FIG. 17, actually within each arrow mark connecting two blocks, namely, between the two blocks, the information transferring section 24 shown in FIG. 1 is provided.

FIG. 18 is a flow chart for illustrating an example of the “processing of recommendation with a hybrid of LSA and other technique”. An example of the “processing of recommendation with a hybrid of LSA and other technique” is described below with reference to the flow chart shown in FIG. 18.

Herein, for instance, it is assumed that a group of metadata M1 of a first type and a group of metadata M2 of a second type, which is different from the first type, are employed, and one of the group of metadata M1 and the group of metadata M2 can influence the other, but not inversely. For instance, the direction of giving influence is the direction from the group of metadata M2 toward the group of metadata M1.

More specifically, for instance, when a musical composition is a target for processing as contents, a feature quantity of the musical composition can be employed as the group of metadata M2, and the context including places, time, situation, emotion, and the like each provided for a user to experience contents can be employed as the group of metadata M1. This is because the feature quantity and context are of a different nature, as is obvious, and at the same time, the context may influence impression of music (feature quantity), but the music (feature quantity) will not directly influence the context.

Further it is assumed that the number s of types exists as a type classified into the group of metadata M1, while the number t types exists as a type classified into the group of metadata M2. The number n contents exist as a target for processing. Namely, the number s+t of metadata is attached to each of the number n of contents.

In this case, as the result of processing by the matrix generating section 18 in step S81 shown in FIG. 18, the matrix A expressed by the following formula (7) is generated as metadata matrix D:

$$A = ( \begin{matrix}{m1}_{0 , 1} & {m2}_{0 , 1} & ⋯ & {m1}_{0 , n - 1} \\ . & & & . \\ {m1}_{s - 1 , 0} & {m1}_{s - 1 , 1} & ⋯ & {m1}_{s - 1 , n - 1} \\ {m2}_{0 , 0} & {m2}_{0 , 1} & ⋯ & {m2}_{0 , n - 1} \\ . & & & . \\ {m2}_{t - 1 , 0} & {m2}_{t - 1 , 1} & ⋯ & {m2}_{t - 1 , n - 1}\end{matrix} ) = ( \frac{Mt1}{Mt2} ) \qquad ( 7 )$$

In the formula (7), mlu, v (u=0 to s−1, v=0 to n−1) is metadata attached to the v-th contents, and represents a component value corresponding to the u-th metadata among the s types of metadata classified into the group of metadata M1. Further, m2w, x (w=0 to t−1, x=0 to n−1) is metadata attached to the x-th contents, and represents a component value corresponding to the w-th metadata among the t types of metadata classified into the group of metadata M2.

In step S82, the matrix generating section 18 divides a metadata matrix into two sub-matrixes. Namely, in this case, in step S82, the matrix generating section 18 divides, as represented on the rightmost side of the formula (7), a metadata matrix into the sub-matrix Mt1 and the sub-matrix Mt2.

The sub-matrix Mt1 represents a matrix including the s rows of matrix components counting from the top of the matrix A, namely, a matrix having mlu, v (u=0 to s−1, v=0 to n−1) as a component value. Thus the sub-matrix Mt1 is a matrix with s rows and n columns.

In contrast to this, the sub-matrix Mt2 represents a matrix including the t rows of matrix components counting from the bottom of the matrix A, namely, a matrix having m2w, x (w=0 to t−1, x=0 to n−1) as a component value. Thus the sub-matrix Mt2 is a matrix with t rows and n columns.

In step S83, the weighting processing section 19 executes weighting with respect to each of the two sub-matrixes.

In step S84, the LSA computing section 20 executes LSA computing to at least one of the two partial matrixes.

The expression of execution of LSA computing to a partial matrix as used herein indicates, in addition to generation of an approximated matrix of a single partial matrix by subjecting the single corresponding to LSA computing, execution of LSA computing to a metadata matrix as a whole and use of components corresponding to the object partial matrix in an approximated matrix of the metadata matrix obtained as a result of LSA computing.

The later case is described in detail below. For instance, in the case described above, when LSA computing is performed to the entire metadata matrix A expressed by the equation (7), the matrix A′ expressed by the following equation (8) is generated as an approximated matrix for the metadata matrix A.

$${A}^{′} = ( \frac{{Mt1}^{′}}{{Mt2}^{′}} ) = {U}_{k} {Σ}_{k} {V}_{k}^{T} \qquad ( 8 )$$

In this case, when the matrix generating section 18 sorts out also the approximated matrix A′ in the completely same way as in the processing in step S82, namely when the matrix generating section 18 sorts out the approximated matrix A′ like in the step S82 in which the metadata matrix A is sorted out as two partial matrixes Mt1, Mt2, the two partial matrixes Mt1′, Mt2′ are obtained as expressed by the equation (8).

The partial matrix Mt1′ is a matrix configured of matrix components for s rows from the top in the approximated matrix A′, namely a matrix having m1u, v with the values updated by LSA computing (u=0 to s−1, v=0 to n−1) as component values. Therefore, also the partial matrix Mt1′ is a matrix having s rows and n columns.

In contrast, the partial matrix Mt2′ is a matrix configured of matrix components for t rows from the bottom in the approximated matrix A′, namely a matrix having m2w, x with the values updated by LSA computing (w=0 to t−1, x=0 to n−1) as component values. Therefore also the partial matrix Mt2′ is a matrix having t rows and n columns.

In this case, for instance, when the partial matrix Mt1 is treated as an object for processing in step S84, the partial matrix Mt1′ expressed by the equation (8) is obtained as a result of the processing in step S84.

In other words, in the processing steps S83 and S84, either one of the first weighting technique performing a singular value decomposition, and the second weighting technique different from the first one is selected discretely for each of the first partial matrix and the second partial matrix sorted out in the processing in step S82 according to the way of mutual influence between the metadata group M1 and metadata group M2, and each of the first partial matrix and second partial matrix is discretely weighted by making use of the weighting technique selected discretely.

The first partial matrix and second partial matrix weighted discretely are obtained by the processing in steps S83 and S84 and are supplied to the matrix generating section 18. Then the processing flows to step S85.

In step S85, the matrix generating section 18 generates an approximated matrix by synthesizing the two partial matrixes.

For instance, in the case described just above, the matrix B expressed by the following equation (9) is generated as an approximated synthesized matrix.

$$B = ( \frac{{Mt1}^{′}}{Mt2} ) \qquad ( 9 )$$

In the equation (9), the partial matrix Mt1′ is the same matrix as that expressed by the equation (8) above. The partial matrix Mt2 is a matrix obtained by weighting the matrix expressed by the equation (7) with the processing in step S83.

When the approximated synthesized matrix B is supplied to the content recommending section 23, and a request for matching is issued from the content recommending section 23 to the vector computing section 22, the processing flows to step S86.

In step S86, the vector computing section 22 executes the contents matching processing by making use of the approximated synthesized matrix B. More specifically, for instance, in step S86, the vector computing section 22 generates UPV from the column components of the approximated synthesized matrix, namely from the content vectors highly evaluated by the user among the content vectors. The vector computing section 22 computes similarity based on the UPV as well as on the existing content vectors, selected the contents having the highest similarity (or any desired number of contents from the one having the highest similarity), and notifies the content recommending section 23 of a result of the selection.

Then in step S87, the content recommending section 23 recommends the contents notified from the vector computing section 22. Namely the content recommending section 23 acquires the contents to be recommended from the content recording section 15, and presents the contents via the user interface section 11.

With this operation, the “recommending processing by a hybrid of LSA and another technique” is terminated.

The “recommending processing by a hybrid of LSA and another technique” is further described below.

As described above, the approximated matrix of the metadata matrix A expressed by the equation (7) is the matrix A′ expressed by the equation (8). The two partial matrixes Mt1′ and Mt2′ sorted out from the approximated matrix A′ are influencing each other due to dimensional compression to the metadata matrix A expressed by the equation (7).

It is assumed herein, for instance, that, in the contents corresponding to row c in the metadata matrix A, both of a weight (component value) m1_{i,c} of the i-th metadata in the metadata group M1 and a weight (component value) m2_{j,c} of the j-th metadata in the metadata group M2 are large. Namely, it is assumed that the two metadata have the cooccurrence relation. In this case, if the weight (component value) of the i-th metadata in the metadata group M1 is large and the weight (component value) of the j-th metadata in the metadata group M2 is small, the weight (component value) for of the j-th metadata is raised because of the characteristics of the dimensional compression based on singular value decomposition by the LSA computing. The same is true also in a case where the relation between the metadata group M1 and metadata group M2 is inverse to the case described above.

The mutual influence between the metadata group M1 and metadata group M2 is effective as weighting in consideration of cooccurrence relation between words as described in the first and second embodiments, for instance, when the document is assumed as a content and a word is assumed as metadata.

In the case described in the fifth embodiment above, however, it is assumed that influence of the metadata group M2 to the metadata group M1 is present and the influence in the reverse direction is not present. In the case based on the premise as described above, there is the desire that only the influence of the metadata group M2 to the metadata group M1 is to be utilized.

To satisfy the requirement as described above, in the fifth embodiment, the approximated synthesized matrix B expressed by the equation (9) above is used as a weighted metadata matrix.

In the approximated synthesized matrix B expressed by the equation (9), the partial matrix Mt2 in the lower section is a metadata matrix A before dimensional compression as described above, namely a partial matrix in the upper section of the matrix obtained by weighting the metadata matrix A expressed by the equation (7) in the processing in step S83. Further the approximated synthesized matrix B expressed by the equation (9), the partial matrix Mt1′ in the upper section is a partial matrix in the upper section of the approximated matrix B expressed by the equation (8).

In the approximated synthesized matrix B expressed by the equation (9), the partial matrix Mt1′ in the upper section is a matrix weighted by taking into consideration the influence of the metadata group M2 over the metadata group M1, while the partial matrix Mt2 in the lower side is a weighted matrix not influenced by the metadata group M1.

Therefore, it may be said that the approximated synthesized matrix B is a weighted metadata approximated matrix based only on the consideration to the one-way influence from the metadata group M2 to the metadata group M1.

Further each of the matrix generating section 18 to computing section 20 can perform weighting to the partial matrix Mt2 in the lower section of the approximated synthesized matrix B by TF/IDF or the like, or generate sub-partial matrixes by further dividing the partial matrix Mt2, and execute weighting to each of the sub-partial matrixes. The weighting in this case includes regressive application of singular value decomposition for realizing only the one-way influence as described above.

In other words, the matrix generating section 18 can further decompose at least one of the first partial matrix and second partial matrix to 2 or more sub-partial matrixes after the first partial matrix and second partial matrix are weighted by the weighting processing section 19 or the LSA computing section 20 respectively, and before an approximated synthesized matrix is generated. In this case, the weighting processing section 19 or the LSA computing section 20 can select either one of the first weighting technique executing singular value decomposition and the second weighting technique different from the first weighting technique discretely to at least one of the two or more sub-partial matrixes and perform weighting by using the selected weighting technique.

The case described above is based on the premise that there is only one-way influence from the metadata group M1 to the metadata group M2 or vice versa, but there often occurs a case in which the metadata group M1 and metadata group M2 are completely independent from each other, yet the cooccurrence relation should be taken into consideration in each metadata group respectively.

In the case as described above, in the processing in step S84, the LSA computing section 20 can perform singular value decomposition to each of the partial matrix Mt1 and partial matrix Mt2 in the equation (7) weighted in the processing in step S83 discretely.

Namely, in the processing in step S84, the LSA computing section 20 executes the singular value decompositions expressed by the following equations (10) and (11) discretely.
Mt1=U₁Σ₁V₁^{T} (10)
Mt2=U₂μ₂V₂^{T} (11)

In addition, the LSA computing section 20 can generates an approximated partial matrix Mt1ₖ₁ and an approximated partial matrix Mt2ₖ₂ by dimensionally compressing the partial matrix Mt1 and partial matrix M2 to dimension K1 and dimension K2 respectively as expressed by the following equations (12) and (13).
Mt1ₖ₁″−U_{1, k1}Σ_{1, k1}V_{1, k1}^{T} (12)
Mt2ₖ₂″=U_{2, k2}Σ_{2, k2}V_{2, k2}^{T} (13)

Therefore, the matrix generating section 18 can generate, in the processing in step S85, an approximated synthesized matrix A″ expressed by the following equation (14).

$${A}^{″} = ( \frac{{Mt1}_{k1}^{″}}{{Mt2}_{k2}^{″}} ) \qquad ( 14 )$$

With the operation described above, the approximated synthesized matrix A″ is provided as a weighted metadata approximated matrix in which the metadata group M1 and metadata group M2 do not give influence to each other and the cooccurrence relation is taken into consideration in each of the groups respectively.

The information processing system or information processing apparatus according to the fifth embodiment of the present invention, namely the information processing system or information processing apparatus for executing the “recommending processing with a hybrid of LSA and other technique” was described above with reference to FIG. 17 and FIG. 18.

In the fifth embodiment, weighting can be performed in each of the metadata group M1 and metadata group M2 by taking into consideration the mutual relation in each of the groups respectively. Further in the fifth embodiment, weighting can be performed by taking into consideration only the influence of the metadata group M2 to the metadata group M1 or influence of the metadata group M1 to the metadata group M2. By using the metadata group M1 and metadata group M2 weighted discretely as described above, the matching processing more appropriate as compared to that in the related art can be performed, and content recommendation can be performed more properly as compared to that in the related art.

The first to fifth embodiments of the present invention were described above.

The processing sequence described in each of the first to fifth embodiments above can be executed by hardware, but can also be executed by software.

In this case, the information processing apparatus shown in FIG. 1 can be realized with a personal computer, for instance, as shown in FIG. 19.

In FIG. 19, a central processing unit (CPU) 101 executes various types of processing according to a program recorded in a Read Only Memory (ROM) 102, or a program loaded from the storage section 108 into a Random Access Memory (RAM) 103. The RAM 103 also stores therein data or the like required for execution of the various types of processing by the CPU 101.

The CPU 101, ROM 102, and RAM 103 are connected to each other via a bus 104. This bus is also connected to an input/output interface 105.

Connected to this input/output interface 105 are an input section 106 including a keyboard, a mouse, and the like, an output section based on a display unit, a storage section 108 based on a hard disk or the like, and a communicating section 109 based on a modem, a terminal adaptor or the like. The communicating section 109 performs communication with other information processing apparatus via a network including the Internet.

A drive 110 is connected to the input/output interface 105 according to the necessity, and a removable recording medium 111 based on a magnetic disk, an optical disk, a magnetic optical disk, or a semiconductor memory is arbitrarily set therein, and a computer program read out from the recording medium 111 is installed in the storage section 108 according to the necessity.

When a series of processing steps are executed by software, programs constituting the software may be incorporated in dedicated hardware for a computer. Alternatively, the program required for executing various types of functions may be installed or downloaded from a network or a recording medium, for instance, in a general-purpose personal computer.

A recording medium including the programs described above is not only the removable recording medium (package medium) 111 based on a magnetic disk (including a floppy disk), an optical disk (including a CD-ROM (Compact Disk-Read Only Memory), a DVD (Digital Versatile Disk)), a magnetic optical disk (including a MD (Mini-Disk)), or a semiconductor memory, but also may be a ROM 102 or a hard disk included in the storage section 108 each with the programs recorded therein and supplied to a user in the state previously assembled in a main body of the device.

In this specification, the processing steps describing a program recorded in a recording medium may not always be executed in chronological order, and may be executed concurrently or discretely.

The word of “system” as used herein indicates an entire device formed with a plurality of devices or processing sections.

While a preferred embodiment of the present invention has been described using specific terms, such description is for illustrative purpose only, and it is to be understood that changes and variations may be made without departing from the spirit or scope of the following claims.

What is claimed is:

1. An information processing apparatus comprising:
a matrix generating unit for vectorizing each of M (integral value of 1 or more) contents among a plurality of contents referring to N (integral value of 1 or more) metadata correlated to at least one of the plurality of contents and generating a matrix including M vectors obtained as a result of vectorization as column components or row components as a metadata matrix;
an approximated matrix generating unit for generating an approximated matrix for the metadata matrix by subjecting the metadata matrix generated by the matrix generating unit to singular value decomposition;
an index value computing unit for computing an index value indicating importance of corresponding metadata for each of the N metadata based on a difference between the metadata matrix generated by the matrix generating unit and the approximated matrix generated by the approximated matrix generating unit; and
an extracting unit for extracting at least one from the N metadata as important metadata having high importance or unnecessary metadata having low importance based on the N index values computed by the index value computing unit.

2. The information processing apparatus according to claim 1,
wherein said index value computing unit successively sets the N metadata as remarked metadata respectively, computes difference values between each of the M row or column component values indicating remarked metadata in the approximated matrix and a corresponding component value in the metadata matrix, and also computes an average value of or a maximum value among the computed M difference values as an index value indicating importance of the remarked metadata.

3. The information processing apparatus according to claim 1,
wherein said index value computing unit successively sets N metadata as remarked metadata respectively, computes quotients obtained by dividing M row or column component values indicating remarked metadata in the approximated matrix by a corresponding component value in the metadata matrix, and computes an average value of or a maximum value among the computed M quotients as an index value indicating importance of the remarked metadata.

4. The information processing apparatus according to claim 1 further comprising:
a recommending unit for deciding one or more contents to be recommended to a user from among the plurality of contents by making use of said important metadata extracted by said extracting unit or metadata excluding said unnecessary metadata extracted by said extracting unit among said N metadata; and
a presenting unit for presenting said contents decided by said recommending unit as those to be recommended to said user.

5. The information processing apparatus according to claim 1 further comprising:
a presenting unit for presenting said important metadata or said unnecessary metadata extracted by said extracting unit to the user.

6. The information processing apparatus according to claim 1 further comprising:
a storage unit for storing therein said important metadata or said unnecessary metadata extracted by said extracting unit.

7. An information processing method comprising the steps of:
generating a matrix, for vectorizing each of M (integral value of 1 or more) contents among a plurality of contents based on N (integral value of 1 or more) metadata correlated to at least one of the plurality of contents and generating a matrix including M vectors obtained as a result of vectorization as column components or row components as a metadata matrix;
generating an approximated matrix, for the metadata matrix, by subjecting the metadata matrix generated in said matrix generating step to singular value decomposition;
computing an index value, in which the index value indicating importance of corresponding metadata for each of the N metadata based on a difference between the metadata matrix generated in the matrix generating step and said approximated matrix generated in said approximated matrix generating step; and
extracting, at least one from the N metadata as important metadata having high importance or unnecessary metadata having low importance based on the N index values computed in said index value computing step.

8. A program to be executed by a computer, comprising the steps of:
generating a matrix, for vectorizing each of M (integral value of 1 or more) contents among a plurality of contents based on N (integral value of 1 or more) metadata correlated to at least one of the plurality of contents and generating a matrix including M vectors obtained as a result of vectorization as column components or row components as a metadata matrix;
generating an approximated matrix, for the metadata matrix, by subjecting the metadata matrix generated in said matrix generating step to singular value decomposition;
computing an index value, in which the index value indicating importance of corresponding metadata for each of the N metadata based on a difference between the metadata matrix generated in the matrix generating step and said approximated matrix generated in said approximated matrix generating step; and
extracting, at least one from the N metadata as important metadata having high importance or unnecessary metadata having low importance based on the N index values computed in said index value computing step.
